(19) United States
(12) Patent Application Publication
(10) Pub. No.: US 2024/0287329 A1
(43) Pub. Date: Aug. 29, 2024

(54) Methods of Additive Manufacturing by Direct Ink Writing of Emulsion Compositions

(71) Applicants: VIRGINIA TECH INTELLECTUAL PROPERTIES, INC., Blacksburg, VA (US); VIRGINIA POLYTECHNIC INSTITUTE AND STATE UNIVERITY, Blacksburg, VA (US); BOARD OF REGENTS OF THE UNIVERSITY OF NEBRASKA, Lincoln (NE)

(72) Inventors: Eric MARKVICKA, Lincoln, NE (US); Aaron HAAKE, Denton, NE (US); Michael D. BARTLETT, Blacksburg, VA (US); Ravi Tej Anand TUTIKA, Christiansburg, VA (US); Gwyneth SCHLOER, Blacksburg, VA (US)

(21) Appl. No.: 18/573,837

(22) PCT Filed: Jun. 23, 2022
(86) PCT No.: PCT/US2022/034801

§ 371 Date: Dec. 22, 2023

Related U.S. Application Data
(60) Provisional application No. 63/214,161, filed on Jun. 23, 2021.
(60) Provisional application No. 63/323,466, filed on Mar. 24, 2022.

(51) Int. Cl. C09D 11/023; B29C 64/118; B29C 64/209; B29K 21/00; B29K 75/00; B29K 83/00; B29K 105/16; B29K 505/00; B33Y 10/00; B33Y 30/00; B33Y 70/10; C09D 11/102; C09D 11/322

(52) U.S. Cl. CPC C09D 11/023; B29C 64/118; B29C 64/209; B33Y 10/00; B33Y 30/00; B33Y 70/10; C09D 11/102; C09D 11/322; B29K 2021/003; B29K 2075/00; B29K 2083/00; B29K 2105/16; B29K 2505/00; B29K 2869/00

(57) ABSTRACT

In accordance with the purpose(s) of the present disclosure, as embodied and broadly described herein, the disclosure, in one aspect, relates to methods of additive manufacture of emulsion compositions. In various aspects, the present disclosure relates to composite materials incorporating microstructures formed by inclusion compositions, and methods of their manufacture. This abstract is intended as a scanning tool for purposes of searching in the particular art and is not intended to be limiting of the present disclosure.

### CROSS-REFERENCE TO RELATED APPLICATIONS

This application claims priority to, and the benefit of, co-pending U.S. provisional application entitled “METHODS OF ADDITIVE MANUFACTURING BY DIRECT INK WRITING OF EMULSION COMPOSITIONS” having Ser. No. 63/323,466, filed Mar. 24, 2022 and co-pending U.S. provisional application entitled “ADDITIVE MANUFACTURING OF FUNCTIONAL EMULSIONS” having Ser. No. 63/214,161, filed Jun. 23, 2021, the contents of both of which are incorporated by reference herein.

### STATEMENT REGARDING FEDERALLY SPONSORED RESEARCH OR DEVELOPMENT

This invention was made with government support under contracts CMMI2054409 and CMMI2054411 awarded by the National Science Foundation, and D18AP00041 awarded by the Defense Advanced Research Projects Agency. The government has certain rights in the invention.

### TECHNICAL FIELD

The present disclosure generally relates to methods of additive manufacturing and articles made therefrom.

### BACKGROUND

Additive manufacturing (AM) of soft materials has enabled the rapid design and fabrication of a wide range of materials and complex geometries. These advancements in manufacturing have led to an emergence of soft matter devices that have tunable physical and functional properties across various length scales, creating soft multifunctional materials including active shape morphing, soft pneumatic channels to create robots and electrically conductive materials. To push these devices towards all soft matter systems, an emerging architecture is to create solid-liquid composite materials with liquid-phase fillers dispersed in soft elastomers. Liquid metals (LMs) like eutectic gallium-indium (EGaIn) have been of particular interest due to their low viscosity, low toxicity, high electrical and thermal conductivity, and rapid formation of a surface oxide. This surface oxide forms nearly instantaneously at low oxygen concentration and allows for physical droplet manipulation and retention of metastable shapes. LM-based solid-liquid composites can be engineered to exhibit a wide range of material properties including extreme toughening, exceptional electrical and thermal properties; shape-morphing; stiffness tuning; and the ability to form electrically conductive pathways through controlled mechanical pressure, deformation, and laser patterning. Key to these composites is the ability of the LM droplets to reconfigure their shape, orientation, and connections. In particular, control over LM microstructure ranging from spherical to ellipsoidal droplet shapes to connected droplet networks is essential for achieving advanced functions and properties; including over 10× enhancements in electrical conductivity, material toughness, and thermal conductivity.

Despite advances in additive manufacturing research, there is still a scarcity of methods and materials that are customizable and tunable on a microstructure scale. These needs and other needs are satisfied by the present disclosure.

### SUMMARY

In accordance with the purpose(s) of the disclosure, as embodied and broadly described herein, the disclosure, in one aspect, relates to methods of additive manufacture of emulsion compositions.

Disclosed are methods of additive manufacture of emulsion compositions. Also disclosed are methods of direct writing using emulsion compositions. Further disclosed are composite materials comprising emulsions of inclusive compositions. Further disclosed are composite materials comprising microstructures formed by inclusive compositions in prepolymer compositions.

Methods are provided for additive manufacturing of an article comprising a composite material; the method comprising: (a) extruding a first emulsion ink composition through a first nozzle to form a first layer of a composite material in a pattern that corresponds to a first layer of an article; wherein the first emulsion ink composition comprises a plurality of discrete droplets of a liquid inclusion composition dispersed within a prepolymer composition; wherein the composite material comprises a plurality of microstructures formed from the liquid inclusion composition embedded within a polymer matrix formed from the prepolymer composition; and wherein a first nozzle height and a first nozzle velocity at which the first emulsion ink composition is extruded from the first nozzle are chosen to control one or more of a shape of a microstructure, an aspect ratio of a microstructure, and a connectivity of microstructures in the plurality of microstructures in the first layer of the article. Articles made by the methods are also provided.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE DRAWINGS

Further aspects of the present disclosure will be readily appreciated upon review of the detailed description of its various embodiments, described below, when taken in conjunction with the accompanying drawings.

FIG. 1A is a photographic image demonstrating the process control that can cause a gradual change in aspect ratio (AR) by simultaneously changing the printing velocity and height, scale bar=500 μm. FIG. 1B is a depiction of the image analysis based visualization of the printed filament LM microstructure from FIG. 1A showing an increase in average aspect ratio (AR) from AR=1.4 to 10.5 with the highest AR>35 as the print velocity (V*) is increased from 1 to 15 and the height (H) is decreased from 300 to 20 μm.

FIG. 2A is a schematic representation of the printing nozzle cross section for printing liquid metal (LM) emulsion inks with direct ink writing. FIG. 2B is schematic 3D visualization of the LM droplets for printing parameters H=20 μm and V*=1. FIG. 2C is schematic 3D visualization of the LM droplets for printing parameters H=20 μm and V*=12. FIG. 2D shows the optical micrographs of printed filaments for printing condition V*=12, H=20 μm, and D=20, 100, 200 μm. FIG. 2E shows the optical micrographs of printed filaments for printing condition V*=1, 3, 6, 12, H=20 μm, and D=200 μm. FIG. 2F shows the optical micrographs of printed filaments for printing condition V*=12, H=20, 70, 150, 250 μm, and D=200 μm. The scale bar=200 μm for FIGS. 2D-2F. FIG. 2G is a series of Gaussian fits to the droplet analysis histograms of the micrographs in FIGS. 2E-2F showing the % droplets as a function of AR for each condition. The inset droplets in the graphs of FIG. 2G represent the mean AR for the corresponding condition.

FIG. 3A is a graph of the stress-strain curves of pure elastomer Ex-Sil (in the inset) and composite filaments with different droplet sizes stretched in tension for V*=1, H=100 μm, and D=20, 100, 200 μm. FIG. 3B includes graphs of the strain at break (top graphs) and tensile modulus (bottom graph) calculated from stress-strain curves for pure elastomer Ex-Sil and composite filaments from FIG. 3A. FIG. 3C is a graph of the cyclic test of a composite filament (V*=1, H=100 μm, and D=200 μm) with 3 cycles at every 100% strain increment up to 500% strain. FIG. 3D is a graph of the stress-strain curves for a single and multi-filament composites stretched in tension for V*=6, H=100 μm, and D=200 μm. FIG. 3E includes graphs of the strain at break (top graphs) and tensile modulus (bottom graph) calculated from stress-strain curves for the pure elastomer (Exsil) and the single filament and multifilament examples of FIG. 3D.

FIG. 4A is an optical micrograph of a printed film with nonlinear, spiral motion path (scale bar=1 mm) demonstrating direct ink writing of printed parts with programmable LM microstructure. FIG. 4B is a schematic illustration of the printed microstructure from FIG. 4A. FIG. 4C is an optical micrograph of the highlighted region defined by the box in FIG. 4A (Scale bar=500 μm). FIG. 4D is an optical micrograph (Scale bar=5 mm) demonstrating direct ink writing of printed parts with programmable LM microstructure. FIG. 4E is a schematic illustration of a printed film with embedded thermal pattern of the letter ‘N’. FIG. 4F is a plot of printing velocity (V*) and printing height (H) as a function of layer number for the 3D structure presented in FIG. 4G. FIG. 4G is a photograph of a fully filled right angled triangular prism printed (133 layers) with schematic illustrations and optical micrographs (Scale bar=200 μm) of LM droplet morphologies at top, middle, and bottom sections of the structure respectively. Scale bar=2 mm for macro photograph in FIG. 4G.

FIG. 5A is a top-view schematic (left) and photograph (right) of the multilayer, multimaterial printed heat sink (LM droplets oriented vertically) with highpower LEDs connected through mask-deposited LM interconnects on the top surface (Scale bar=5 mm). FIG. 5B is a plot of average temperature of the LEDs in unfilled silicone elastomer and composite elastomer with oriented LM droplet regions for the device in FIG. 5A, shaded regions represent the standard deviation of the temperature of the two regions.

FIG. 6A is a schematic illustrating the exemplary printing process conditions that can be utilized to achieve full control of LM droplet shape, orientation, and connectivity throughout a printed part using a single printing nozzle and emulsion ink. FIG. 6B is an optical micrograph of LM droplets in the printed film starting from electrically insulating (left) spherical droplets to (middle) elongated droplets to (right) connected networks that are electrically conductive (Scale bar=500 μm). FIG. 6C is a schematic illustration of the shape, orientation, and connectivity of the LM droplets in the printed film from FIG. 6B.

FIG. 7 is a collection of optical micrographs of composite filaments with D=200 μm and for variation of printing parameters V*=1, 3, 6, 12 and H=20, 70, 150, 250 μm. Scale bar=200 μm.

FIG. 8 is a collection of particle analysis histograms of aspect ratio (AR) and Gaussian fits of composite filaments with D=200 μm and for variation of printing parameters V*=1, 3, 6, 12 and H=20, 70, 150, 250 μm.

FIG. 9 is an optical micrograph of composite filaments printed with GelestExSil100 Matrix, 30 vol % EGaIn (scale bar 500 micron) demonstrating the ability to achieve high aspect ratio elongated droplets in the printed parts.

FIG. 10 is an optical micrograph of composite filaments printed with Smooth-On Ecoflex00-30 Matrix, 50 vol % EGaIn (scale bar 200 micron) demonstrating the ability to achieve high aspect ratio elongated droplets in the printed parts.

FIG. 11 is an optical micrograph of composite filaments printed with Sylgard184 Matrix, 50 vol % EGaIn (scale bar 500 micron) demonstrating the ability to achieve high aspect ratio elongated droplets in the printed parts.

FIG. 12 is an optical micrograph of composite filaments printed with DOWSIL SE 1700 Matrix, 50 vol % EGaIn (scale bar 200 micron) demonstrating the ability to achieve high aspect ratio elongated droplets in the printed parts.

### DETAILED DESCRIPTION

By reconfiguring isolated spherical LM droplets into a connected network, an initially insulating film can be transformed into electrically conductive traces, which are also self-healing by the subsequent reconfiguration of droplets from damage events. Strain-invariant electrical resistance, which goes against kinematic predictions from Pouillet's Law, can be achieved as droplet networks deform under strain. While isolated ellipsoidal and oriented LM droplets create thermally conductive pathways to increase thermal conductivity over spherical droplets and deect cracks to increase toughness. These results demonstrate that material properties and performance are strongly dependent upon droplet microstructure and connectivity, spatial placement and orientation, and volume loading. However, common fabrication approaches using bulk replica molding, soft lithography, or patterning techniques result in primarily spherical inclusions with little control of shape, orientation, or spatial placement. While, connected LM droplet networks are typically formed using secondary operations or through the addition of a rigid filler. New fabrication processes are needed to enable spatial control of inclusion morphology and connectivity during fabrication to achieve programmable LM microstructures for systematic control of material properties and device performance.

Direct ink writing (DIW) is a filament-based AM method that allows printing of high-viscosity fluids, concentrated polymer solutions, and high-volume percent fillers at ambient conditions. A variety of DIW methods and inks have been developed to achieve alignment of fillers such as magnetic particles, liquid crystal molecules, high-aspect ratio fibers, and cellulose fibrils. While the orientation of fillers can be controlled, the aspect ratio remains fixed during printing due to the relatively rigid, non-deformable properties of the filler. Recently, the ability to DIW emulsions with LM inclusions was demonstrated, however the combination of printing process conditions and LM droplet size resulted in primarily spherical inclusions. Liquid inclusions can be elongated under mechanical deformation by inducing unrecoverable plastic strain or thermal annealing of composites after stretching, however these approaches require specific materials, lack spatial control, and only allow for elongation of inclusions along a single axis. While significant progress has been made towards achieving spatial control of composition, structure, and properties during DIW, emulsion-based inks offer new opportunities to not only control orientation but the shape and connectivity of LM fillers during the fabrication process.

Herein, a new DIW 3D printing strategy is introduced to achieve on demand programming of LM composite microstructures throughout a printed part. The functional emulsion ink consists of spherical LM microdroplets dispersed in a prepolymer matrix that can be printed and then cured into a soft and highly extensible elastomeric composite. By systematically controlling the printing process conditions and LM droplet size, we were able to transform the initially spherical LM droplets into highly elongated and orientated ellipsoids on demand at any location with very high aspect ratios (AR; major/minor ellipsoid axis). The rapid formation of the surface oxide locks these droplets into the programmed shape and allows for systematic control of the LM droplet microstructure throughout a printed part. In addition to shape and orientation, we can also transform the initially isolated LM droplets into a connected network using the same ink and manufacturing system. This on demand spatial control of LM microstructure (i.e., shape, orientation, and connectivity) has not been demonstrated with currently available casting, stretching, or patterning approaches. To rationally guide the DIW printing process, we created a quantitative design map as a function of the printing parameters, which shows that the LM microdroplet AR increases with nondimensionalized nozzle velocity and decreasing nozzle height. Utilizing the quantitative design map, we printed elastomer composites with unique LM microdroplet patterns such as smooth and discrete transitions from spherical to needle-like microstructures, curvilinear microstructures, geometrically complex thermal patterns, and embedded heat spreaders. We also create 3D structures that contain spatial variations in droplet shape in 3D configurations. These capabilities not only advance the manufacturing of LM-composites, but demonstrate new capabilities in DIW to tune inclusion shape, orientation, and connectivity on demand in composite materials, which is achieved through the use of liquid-phase fillers and is uniquely enabled by LM inclusions rapidly forming a surface oxide shell to lock in the programmed microstructure. The systematic integration of DIW 3D printing with advanced multifunctional materials provides opportunities to create composite architectures for emerging technologies such as soft robotics, human-machine interaction, and wearable electronics that demand mechanical compliance with a highly tunable functional response.

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list of elements and do not modify the individual elements of the list.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

Reference to “a” chemical compound refers to one or more molecules of the chemical compound rather than being limited to a single molecule of the chemical compound. Furthermore, the one or more molecules may or may not be identical, so long as they fall under the category of the chemical compound. Thus, for example, “a” chemical compound is interpreted to include one or more molecules of the chemical, where the molecules may or may not be identical (e.g., different isotopic ratios, enantiomers, and the like).

As used in the specification and the appended claims, the singular forms “a,” “an” and “the” include plural referents unless the context clearly dictates otherwise. Thus, for example, reference to “a metal oxide,” “an inert gas,” or “a catalyst,” includes, but is not limited to, two or more such articles, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

### Emulsion Inks and Methods of Making Thereof

In various aspects, emulsion inks are provided that can be used for carrying out the methods and making the articles described herein. Emulsion ink compositions include a plurality of discrete droplets of a liquid inclusion composition dispersed within a prepolymer composition. A variety of liquid inclusion compositions can be controllably formatted in a variety of different prepolymer compositions to form emulsion inks having various particle sizes, volume loadings, and rheological properties such as the modulus and shear rate dependent viscosity.

In some aspects, the particle sizes include mean particle diameters from about 0.5 micron, 1 micron, 5 micron, 10 micron, 15 micron and up to about 200 micron, 250 micron, 300 micron, 400 micron, 500 micron, or more. The volume loading of the liquid inclusion composition can be from about 10% and up to about 80% e.g., from about 10 vol %, 20 vol %, 30 vol %, 40 vol % and up to about 50 vol %, 60 vol %, 70 vol %, 80 vol %, or more. The particle diameters and the loading volume can be controllably altered using techniques such as shear mixing, sonication, the use of surfactants, the use of solvent to lower viscosity where the solvents can be subsequently evaporated or removed, and other techniques that will become apparent to those skilled in the art.

The liquid inclusion composition can in principal include any liquid having suitable rheological properties and be chosen to provide valuable functional aspects to the articles made from the emulsion inks. In some aspects, the liquid inclusion composition is or includes a liquid metal. A liquid metal is a metal or a metal alloy which is liquid at or near room temperature. In some aspects, the liquid metal is mercury (Hg), cesium (Cs), gallium (Ga), rubidium (Rb), francium (Fr), indium (In), bismuth (Bi), tin (Sn), cadmium (Cd), thallium (TI), antimony (Sb), or alloys thereof and alloys including one or more other metals. In some aspects, the liquid metal includes GaIn or other Ga alloys.

The emulsion ink includes one or more prepolymers forming the prepolymer composition. The prepolymer composition can include an elastomer, a thermoset, a thermoplastic, and/or photocurable resin, For example, the prepolymer may be selected from the group consisting of acrylonitrile butadiene styrene (ABS), polylactic acid (PLA), poly(methyl methacrylate) (PMMA), epoxy, polydimethylsiloxane (PDMS), polyamide (Nylon), polyimide (PI), polyethylene (PE), polypropylene (PP), polystyrene (PS), polytetrafluorethylene (PTFE), polyvinylchloride (PVC), polyurethane (PU), polycarbonate (PC), photocurable resins, epoxies, and hydrogels. The prepolymer can include various silicone resins. Suitable elastomers can include silicone, polyurethane, thermoplastic elastomers, or a combination thereof. Suitable thermosets can include epoxies, polyesters, polyurethanes, polyimides, acrylonitriles, copolymers thereof, and blends thereof. Suitable thermoplastics can include polyolefins, polystyrenes, polyesters, polycarbonates, nylons, acrylics, polyacrylates, butyl, polybutenes, polyisobutylenes, liquid crystal polymers (LCP), ethylene copolymers, vinyl chloride, polyvinyl chloride (PVC), ionomers, ketones, polyamides, polyether block amide (PBA), polyphenylene oxide (PPO), polyphenylene sulphide (PPS), acrylonitrile butadiene styrene (ABS), polylactic acid (PLA), polyethylene terephthalate glycol-modified (PETG), nylon, copolymers thereof, and blends thereof.

The loading volume, particle size, and rheological properties of the emulsion ink can be controllably altered with various additional additives or components. For example, surfactants can be used to stabilize various emulsions having specific matrices and/or particle size and loading. Solvents can be used to assist in the mixing to achieve targeted volume loading, which can be later removed by evaporation or otherwise. Blends of polymers can also be used to achieve the targeted rheological properties. Tuning the modulus and shear rate dependent viscosity can be achieved through additives. Blends can further include rheology modifying agents such as fumed silica or silver flakes.

### Direct Ink Writing of Emulsion Inks and Articles Made Therefrom

In various aspects, methods of additive manufacturing of an article using emulsion inks. The methods can include extruding a first emulsion ink composition through a first nozzle to form a first layer of a composite material in a pattern that corresponds to a first layer of an article. A single layer can include one or multiple different inks. In some aspects, there are two, three, four, or more inks used to spatially vary the properties of the printed articles. In other aspects, the properties are varied using a single ink but by controlling an aspect ratio of the liquid inclusion complexes in the emulsion ink as it is extruded. In instances where the method includes using multiple inks, some of the inks can lack the liquid inclusion complex. For example, by additive manufacturing with conventional polymers in a second ink along with emulsion inks, complex architectures can be created while only depositing the liquid inclusion complexes where needed.

In some aspects, a first nozzle height and a first nozzle velocity at which the first emulsion ink composition is extruded from the first nozzle are chosen to control one or more of a shape of a microstructure, an aspect ratio of a microstructure, and a connectivity of microstructures in the plurality of microstructures in the first layer of the article. Applicants have demonstrated that by controlling the nozzle height and the nozzle velocity (often referred to using the nondimensional velocity V* as described elsewhere herein), the aspect ratio of the liquid inclusion complex can be precisely controlled. In some aspects, controlling these parameters can control a shape of a microstructure, an aspect ratio of a microstructure, and a connectivity of microstructures in the plurality of microstructures in the article.

In some aspects, a method of additive manufacturing of an article is provided that includes extruding a first emulsion ink composition through a first nozzle to form a first layer of a composite material in a pattern that corresponds to a first layer of an article; wherein the first emulsion ink composition comprises a plurality of discrete droplets of a liquid inclusion composition dispersed within a prepolymer composition; wherein the composite material comprises a plurality of microstructures formed from the liquid inclusion composition embedded within a polymer matrix formed from the prepolymer composition; and wherein a first nozzle height and a first nozzle velocity at which the first emulsion ink composition is extruded from the first nozzle are chosen to control one or more of a shape of a microstructure, an aspect ratio of a microstructure, and a connectivity of microstructures in the plurality of microstructures in the first layer of the article.

In some aspects, the method can be completed multiple times to build an article in a layer by layer approach. By varying the nozzle height and nozzle velocity or the ink compositions for each layer, the properties can be controllably varied within layers and between layers. In some aspects, the method includes extruding a second emulsion ink composition through a second nozzle to form a subsequent layer of a composite material in a pattern that corresponds to a subsequent layer of the article; wherein the subsequent later is formed on either the first layer of the article or another subsequent layer of the article; wherein the second emulsion ink composition comprises a plurality of discrete droplets of a liquid inclusion composition dispersed within a prepolymer composition; wherein the subsequent layer of the composite material comprises a plurality of microstructures formed from the liquid inclusion composition embedded within a polymer matrix formed from the prepolymer composition; and wherein a second nozzle height and a second nozzle velocity at which the second emulsion ink composition is extruded from the nozzle are chosen to control one or more of a shape of a microstructure, an aspect ratio of a microstructure, and a connectivity of a microstructure in the plurality of microstructures in the second layer of the article.

In some aspects, the methods can include forming regions in the article wherein the liquid inclusion complex becomes interconnected upon printing. For example, the methods can include disturbing a layer of the composite material to interconnect one or more distinct microstructures of inclusion material. The interconnection can also be controlled through the printing process, whereby very high aspect ratios are achieved such that the inclusion compositions become interconnected. O or both of the first nozzle height and the first nozzle velocity can be chosen to interconnect two or more of the droplets to form interconnected microstructures. This can be particular advantageous, for instance, when the inclusion composition is electrically conductive. This can allow for the creation of electrically conductive and electrically insulating regions within the some article and using the same ink.

### Aspects of the Disclosure

This disclosure will be better understood upon reading the following numbered aspects which should not be confused with the claims. Each of the aspects described below may, in other aspects, be combined with each other or be combined with aspects described elsewhere herein including aspects described above and any aspects demonstrated in the examples which follow.
Aspect 1. A method of additive manufacturing of an article comprising a composite material; the method comprising: (a) extruding a first emulsion ink composition through a first nozzle to form a first layer of a composite material in a pattern that corresponds to a first layer of an article; wherein the first emulsion ink composition comprises a plurality of discrete droplets of a liquid inclusion composition dispersed within a prepolymer composition; wherein the composite material comprises a plurality of microstructures formed from the liquid inclusion composition embedded within a polymer matrix formed from the prepolymer composition; and wherein a first nozzle height and a first nozzle velocity at which the first emulsion ink composition is extruded from the first nozzle are chosen to control one or more of a shape of a microstructure, an aspect ratio of a microstructure, and a connectivity of microstructures in the plurality of microstructures in the first layer of the article.
Aspect 2. The method of any one of Aspects 1-39, further comprising: (b) extruding a second emulsion ink composition through a second nozzle to form a subsequent layer of a composite material in a pattern that corresponds to a subsequent layer of the article; wherein the subsequent later is formed on either the first layer of the article or another subsequent layer of the article; wherein the second emulsion ink composition comprises a plurality of discrete droplets of a liquid inclusion composition dispersed within a prepolymer composition; wherein the subsequent layer of the composite material comprises a plurality of microstructures formed from the liquid inclusion composition embedded within a polymer matrix formed from the prepolymer composition; and wherein a second nozzle height and a second nozzle velocity at which the second emulsion ink composition is extruded from the nozzle are chosen to control one or more of a shape of a microstructure, an aspect ratio of a microstructure, and a connectivity of a microstructure in the plurality of microstructures in the second layer of the article.
Aspect 3. The method of any one of Aspects 1-39, wherein step (b) is repeated multiple times to form the article in a layer-by-layer approach.
Aspect 4. The method of any one of Aspects 1-39, wherein the aspect ratio of at least one of the microstructures formed from the inclusion composition is from about 1, about 1.5, about 2, about 2.5, about 3, about 3.5, about 4, about 4.5, about 5, about 10, about 20, about 30, about 40, about 50, about 60, about 70, about 80, about 100, about 200, about 300, about 400, up to about 500.
Aspect 5. The method of any one of Aspects 1-39, wherein the mean aspect ratio of the microstructures formed from the inclusion composition is from about 1 to about 500.
Aspect 6. The method of any one of Aspects 1-39, wherein the mean aspect ratio of the microstructures formed from the inclusion composition is from about 1 to about 100.
Aspect 7. The method of any one of Aspects 1-39, wherein the mean aspect ratio of the microstructures formed from the inclusion composition is from about 1 to about 50.
Aspect 8. The method of any one of Aspects 1-39, wherein the mean aspect ratio of the microstructures formed from the inclusion composition is from about 1 to about 10.
Aspect 9. The method of any one of Aspects 1-39, wherein the mean aspect ratio of the microstructures formed from the inclusion composition is from about 1 to about 2.
Aspect 10. The method of any one of Aspects 1-39, wherein the inclusion composition comprises a liquid metal.
Aspect 11. The method of any one of Aspects 1-39, wherein the inclusion composition includes a surface tension modifier.
Aspect 12. The method of any one of Aspects 1-39, wherein the liquid metal is selected from the group consisting of gallium (Ga), rubidium (Rb), cesium (Cs), francium (Fr), indium (In), bismuth (Bi), tin (Sn), cadmium (Cd), thallium (TI), antimony (Sb), alloys thereof and alloys with other elements, and mixtures thereof.
Aspect 13. The method of any one of Aspects 1-39, wherein the liquid metal comprises a gallium-indium alloy.
Aspect 14. The method of any one of Aspects 1-39, wherein the inclusion composition is capable of forming an oxidative layer upon exposure to the atmosphere.
Aspect 15. The method of any one of Aspects 1-39, wherein the inclusion composition forms an oxide layer on the surface of the formed microstructures.
Aspect 16. The method of any one of Aspects 1-39, wherein the prepolymer composition comprises an elastomer.
Aspect 17. The method of any one of Aspects 1-39, wherein the elastomer comprises silicone, polyurethane, thermoplastic elastomers, or a combination thereof.
Aspect 18. The method of any one of Aspects 1-39, wherein the prepolymer composition comprises a thermoset, wherein the thermoset is selected from the group consisting of epoxies, polyesters, polyurethanes, polyimides, acrylonitriles, copolymers thereof, and blends thereof.
Aspect 19. The method of any one of Aspects 1-39, wherein the prepolymer composition comprises a thermoplastic, wherein the thermoplastic is selected from the group consisting of polyolefins, polystyrenes, polyesters, polycarbonates, nylons, acrylics, polyacrylates, butyl, polybutenes, polyisobutylenes, liquid crystal polymers (LCP), ethylene copolymers, vinyl chloride, polyvinyl chloride (PVC), ionomers, ketones, polyamides, polyether block amide (PBA), polyphenylene oxide (PPO), polyphenylene sulphide (PPS), copolymers thereof, and blends thereof.
Aspect 20. The method of any one of Aspects 1-39, wherein the thermoplastic comprises acrylonitrile butadiene styrene (ABS), polylactic acid (PLA), polyethylene terephthalate glycol-modified (PETG), nylon, or a combination thereof.
Aspect 21. The method of any one of Aspects 1-39, wherein the droplets of the liquid inclusion composition in the first emulsion ink are from about 1 μm, about 5 μm, about 10 μm, or about 20 μm and up to about 300 μm, 500 μm, 800 μm, or 1000 μm in diameter, wherein the diameter of a given droplet is defined as the diameter of a perfectly spherical droplet comprising the same volume of the droplet.
Aspect 22. The method of any one of Aspects 1-39, wherein the diameter is between about 50 μm and about 500 μm.
Aspect 23. The method of any one of Aspects 1-39, wherein the diameter is between about 200 μm and about 500 μm.
Aspect 24. The method of any one of Aspects 1-39, further comprising (b or c) disturbing the first layer of the composite material to interconnect one or more distinct microstructures of inclusion material.
Aspect 25. The method of any one of Aspects 1-39, wherein one or both of the first nozzle height and the first nozzle velocity are chosen to interconnect two or more of the droplets to form interconnected microstructures.
Aspect 26. The method of any one of Aspects 1-39, wherein the composite material is electrically conductive.
Aspect 27. The method of any one of Aspects 1-39, wherein the composite material is electrically insulating.
Aspect 28. The method of any one of Aspects 1-39, wherein the microstructures are interconnected so that the composite material is electrically conducting.
Aspect 29. The method of any one of Aspects 1-39, wherein at least one of the microstructures of liquid inclusion composition is curvilinear.
Aspect 30. The method of any one of Aspects 1-39, wherein greater than 50% of the microstructures of liquid inclusion composition is curvilinear.
Aspect 31. The method of any one of Aspects 1-39, wherein a mean aspect ratio of the plurality of microstructures in the first layer is from about 1, about 1.1, about 1.2. about 1.5 and up to about 10, about 50, about 100, or about 500.
Aspect 32. The method of any one of Aspects 1-39, wherein a standard deviation of an aspect ratio of the plurality of microstructures in the first layer is about 5, about 2, about 1, about 0.5, about 0.3, or less.
Aspect 33. The method of any one of Aspects 1-39, wherein one or both of the first layer of the composite material and the subsequent layer of the composite material are cured using one or more of heat and UV light to form the polymer matrix.
Aspect 34. The method of any one of Aspects 1-39, wherein one or both of the first nozzle height and the first nozzle velocity are controllably modified as the first layer is extruded so that one or more of a shape of a microstructure, an aspect ratio of a microstructure, and a connectivity of microstructures varies across the first layer.
Aspect 35. The method of any one of Aspects 1-39, wherein one or both of the second nozzle height and the second nozzle velocity are controllably modified as the subsequent layer is extruded so that one or more of a shape of a microstructure, an aspect ratio of a microstructure, and a connectivity of microstructures varies across the subsequent layer.
Aspect 36. The method of any one of Aspects 1-39, wherein a shape of a microstructure is controllably varied in one or both of the first layer and a subsequent layer; wherein the shape being controllable varied includes one or more of: (a) a spherical microstructure being nearby or adjacent to an elongated microstructure in the same layer; (b) a gradual progression of an aspect ratio of a plurality of microstructures across the same layer from a lower aspect ratio to a higher aspect ratio; (c) a long axis of an elongated microstructure having an orientation that is not aligned with a long axis of a second elongated microstructure in the same layer; and (d) interconnected microstructures adjacent to discrete microstructures in the same layer.
Aspect 37. T The method of any one of Aspects 1-39, wherein the first emulsion ink and the second emulsion ink are the same.
Aspect 38. The method of any one of Aspects 1-39, wherein the first emulsion ink and the second emulsion ink are different.
Aspect 39. The method of any one of Aspects 1-38, wherein the prepolymer composition of the first emulsion ink and the prepolymer composition of the second emulsion ink are the same; and wherein the first liquid inclusion composition of the first emulsion ink and the liquid inclusion composition of the second emulsion ink are different.
Aspect 40. An article formed by a method according to any one of Aspects 1-39.
Aspect 41. An article comprising an inclusion composition and a polymer matrix wherein the inclusion composition is dispersed within the polymer matrix as distinct microstructures of inclusion material; wherein the mean aspect ratio of the microstructures of inclusion material is from about 1, about 1.5, about 2, about 2.5, about 3, about 3.5, about 4, about 4.5, about 5, about 10, about 20, about 30, about 40, about 50, about 60, about 70, about 80, about 100, about 200, about 300, about 400, up to about 500.
Aspect 42. The article of any one of Aspects 40-80, wherein the inclusion composition comprises a liquid metal.
Aspect 43. The article of any one of Aspects 40-80, wherein the liquid metal is selected from the group consisting of gallium (Ga), rubidium (Rb), cesium (Cs), francium (Fr), indium (In), bismuth (Bi), tin (Sn), cadmium (Cd), thallium (TI), antimony (Sb), alloys thereof and alloys with other elements, and mixtures thereof.
Aspect 44. The article of any one of Aspects 40-80, wherein the liquid metal comprises a gallium-indium alloy.
Aspect 45. The article of any one of Aspects 40-80, wherein the inclusion composition is capable of forming an oxidative layer upon exposure to the atmosphere.
Aspect 46. The article of any one of Aspects 40-80, wherein at least one of the microstructures of inclusion material is curvilinear.
Aspect 47. The article of any one of Aspects 40-80, wherein at least 50% of the microstructures of inclusion material is curvilinear.
Aspect 48. The article of any one of Aspects 40-80, wherein the polymeric matrix comprises an elastomer.
Aspect 49. The article of any one of Aspects 40-80, wherein the elastomer comprises silicone, polyurethane, thermoplastic elastomers, or a combination thereof.
Aspect 50. The article of any one of Aspects 40-80, wherein the elastomer comprises Gelest ExSil 100, Smooth-On Ecoflex 00-30, Sylgard 184 Matrix, or DOWSIL SE 1700.
Aspect 51. The article of any one of Aspects 40-80, wherein the polymer matrix comprises a thermoset, wherein the thermoset is selected from the group consisting of epoxies, polyesters, polyimides, acrylonitriles, copolymers thereof, and blends thereof.
Aspect 52. The article of any one of Aspects 40-80, wherein the polymer matrix comprises a thermoplastic, wherein the thermoplastic is selected from the group consisting of polyolefins, polystyrenes, polyesters, polycarbonates, nylons, acrylics, polyacrylates, butyl, polybutenes, polyisobutylenes, liquid crystal polymers (LCP), ethylene copolymers, vinyl chloride, polyvinyl chloride (PVC), ionomers, ketones, polyamides, polyether block amide (PBA), polyphenylene oxide (PPO), polyphenylene sulphide (PPS), copolymers thereof, and blends thereof.
Aspect 53. The article of any one of Aspects 40-80, wherein the thermoplastic comprises acrylonitrile butadiene styrene (ABS), polylactic acid (PLA), polyethylene terephthalate glycol-modified (PETG), nylon, or a combination thereof.
Aspect 54. The article of any one of Aspects 40-80, wherein the composite material is electrically conductive.
Aspect 55. The article of any one of Aspects 40-80, wherein the composite material is electrically insulating.
Aspect 56. The article of any one of Aspects 40-80, wherein the composite material is present in an article of manufacture.
Aspect 57. The article of any one of Aspects 40-80, for use in additive manufacturing of an article.
Aspect 58. The article of any one of Aspects 40-80, comprising an inclusion composition and a polymer matrix, wherein the inclusion composition is dispersed within the polymer matrix as distinct microstructures of inclusion material; wherein the mean aspect ratio of the microstructures of inclusion material is from about 1, about 1.5, about 2, about 2.5, about 3, about 3.5, about 4, about 4.5, about 5, about 10, about 20, about 30, about 40, about 50, about 60, about 70, about 80, about 100, about 200, about 300, about 400, up to about 500.
Aspect 59. The article of any one of Aspects 40-80, wherein the mean aspect ratio of the microstructures formed from the inclusion composition is from about 1 to about 500.
Aspect 60. The article of any one of Aspects 40-80, wherein the mean aspect ratio of the microstructures formed from the inclusion composition is from about 1 to about 100.
Aspect 61. The article of any one of Aspects 40-80, wherein the mean aspect ratio of the microstructures formed from the inclusion composition is from about 1 to about 50.
Aspect 62. The article of any one of Aspects 40-80, wherein the mean aspect ratio of the microstructures formed from the inclusion composition is from about 1 to about 10.
Aspect 63. The article of any one of Aspects 40-80, wherein the mean aspect ratio of the microstructures formed from the inclusion composition is from about 1 to about 2.
Aspect 64. The article of any one of Aspects 40-80, wherein the inclusion composition comprises a liquid metal.
Aspect 65. The article of any one of Aspects 40-80, wherein the liquid metal is selected from the group consisting of gallium (Ga), rubidium (Rb), cesium (Cs), francium (Fr), indium (In), bismuth (Bi), tin (Sn), cadmium (Cd), thallium (TI), antimony (Sb), alloys thereof and alloys with other elements, and mixtures thereof.
Aspect 66. The article of any one of Aspects 40-80, wherein the inclusion composition is capable of forming an oxidative layer upon exposure to the atmosphere.
Aspect 67. The article of any one of Aspects 40-80, wherein at least one of the microstructures of inclusion material is curvilinear.
Aspect 68. The article of any one of Aspects 40-80, wherein at least 50% of the microstructures of inclusion material is curvilinear.
Aspect 69. The article of any one of Aspects 40-80, wherein the polymer composition comprises an elastomer.
Aspect 70. The article of any one of Aspects 40-80, wherein the elastomer comprises a silicone.
Aspect 71. The article of any one of Aspects 40-80, wherein the elastomer comprises Gelest ExSil 100, Smooth-On Ecoflex 00-30, Sylgard 184 Matrix, or DOWSIL SE 1700.
Aspect 72. The article of any one of Aspects 40-80, wherein the polymer composition comprises a thermoset, wherein the thermoset is selected from the group consisting of epoxies, polyesters, polyimides, acrylonitriles, copolymers thereof, and blends thereof.
Aspect 73. The article of any one of Aspects 40-80, wherein the polymer composition comprises a thermoplastic, wherein the thermoplastic is selected from the group consisting of polyolefins, polystyrenes, polyesters, polycarbonates, nylons, acrylics, polyacrylates, butyl, polybutenes, polyisobutylenes, liquid crystal polymers (LCP), ethylene copolymers, vinyl chloride, polyvinyl chloride (PVC), ionomers, ketones, polyamides, polyether block amide (PBA), polyphenylene oxide (PPO), polyphenylene sulphide (PPS), copolymers thereof, and blends thereof.
Aspect 74. The article of any one of Aspects 40-80, wherein the thermoplastic comprises acrylonitrile butadiene styrene (ABS), polylactic acid (PLA), polyethylene terephthalate glycol-modified (PETG), nylon, or a combination thereof.
Aspect 75. The article of any one of Aspects 40-80, wherein the composite material is electrically conductive.
Aspect 76. The article of any one of Aspects 40-80, wherein the composite material is electrically insulating.
Aspect 77. The article of any one of Aspects 40-80, wherein the composite material is present in an article of manufacture.
Aspect 78. The article of any one of Aspects 40-80, wherein the article is a heat-sink and a plurality of the microstructures are oriented to preferentially conduct heat in a direction within the article.
Aspect 79. The article of any one of Aspects 40-80, wherein the article is or comprises an electronic component and a plurality of the microstructures are interconnected to form one or more electrically conductive paths within the composite material.
Aspect 80. The article of any one of Aspects 40-79, wherein the article comprises both an electronic component and a heat sink integrated into the same article, wherein a first plurality of the microstructures are oriented to preferentially conduct heat in a direction within the article; and a second plurality of the microstructures are interconnected to form one or more electrically conductive paths within the composite material.

### EXAMPLES

Now having described the various aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of aspects of the present disclosure. In particular, while the examples provide one or more specific aspects, in other aspects the examples may be combined with aspects described elsewhere herein, including in the numbered aspects above.

### Example 1. Direct Ink Write 3D Printing of Functional Emulsion Eutectic Gallium Indium Alloy Inks

The exampled demonstrate a direct ink writing technique to program LM microstructure (i.e., shape, orientation, and connectivity) on demand throughout elastomer composites. In contrast to inks with rigid particles that have fixed shape and size, the example demonstrates that emulsion inks with LM fillers enable in-situ control of microstructure. This enables filaments, films, and 3D structures with unique LM microstructures that are generated on demand and locked in during printing. This includes smooth and discrete transitions from spherical to needle-like droplets, curvilinear microstructures, geometrically complex embedded inclusion patterns, and connected LM pathways. The printed materials are soft (modulus<200 kPa), highly deformable (>600% strain), and can be made locally insulating or electrically conductive using a single ink (in this case a gallium indium alloy) by controlling process conditions. This example demonstrates embedding elongated LM droplets in a soft heat sink, which rapidly dissipates heat from high power LEDs. These programmable microstructures enable new composite paradigms for emerging technologies that demand mechanical compliance with multifunctional response.

### Materials and Fabrication of LM Ink

The LM emulsion inks were fabricated by dispersing microdroplets of eutectic gallium indium alloy (Ga:In in the ratio 3:1 by mass) in a two-component silicone elastomer (Ex-Sil™ 100; Gelest Inc.). First, the two-part silicone prepolymer was prepared by combining part A and part B at a 100:1 ratio by mass, then mixing and degassing in a planetary centrifugal mixer (Flaktek™ Speedmixer). The emulsion was formed by adding LM at 50% by volume to the silicone prepolymer and further mixing for 1 min at 2300 rpm for D=20 μm and 800 rpm for D=100, 200 μm. To obtain the D=200 μm size, hexane was added to the elastomer in a 1:8 ratio by weight before the addition of LM. The hexane was removed before printing by placing the ink in a vacuum chamber for 2.5 hours. To ensure a similar treatment before printing, the inks with D=20, 100 μm were also degassed to remove trapped air voids and allowed to sit for 2.5 hours after mixing. The ink was then loaded into a syringe for DIW, printed, and cured in a convection oven at 100° C. for 24 hours.

### Direct Ink Writing Setup

A Hyrel Engine SR 3D printer with SDS-10 head was modified to level the bed. A thin layer of Sylgard 184 (10:1 ratio) was cast on the aluminum bed and a 170×170 mm glass sheet was placed on the top. A thin layer of Ecoflex 00-30 was spin coated on a 70 mm diameter glass disk, which was attached to the glass sheet on the bed. Single-layer prints are printed on a 4-mil PET film (McMaster-Carr) adhered to the Ecoflex bed for convenience of removal and handling. Optimum® SmoothFlow™ nozzles (Nordson EFD) with 0.84 mm diameter were used to extrude the ink. An extrusion velocity of C=6.8 mm-s-1 was used for V*=1, 3, 6 filaments, and C=4.2 mm-s-1 was used for V*=12 filaments. Print head velocity was V=6.8, 20.4, 40.8, and 50.4 for V*=1, 3, 6, 12 filaments, respectively.

### Multilayer and Multimaterial Printing

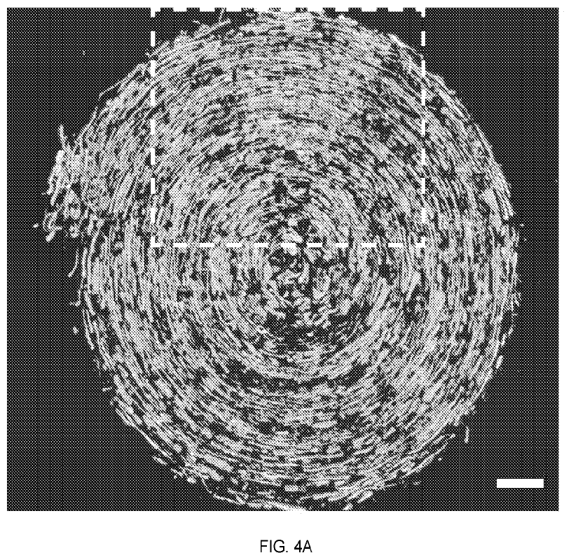

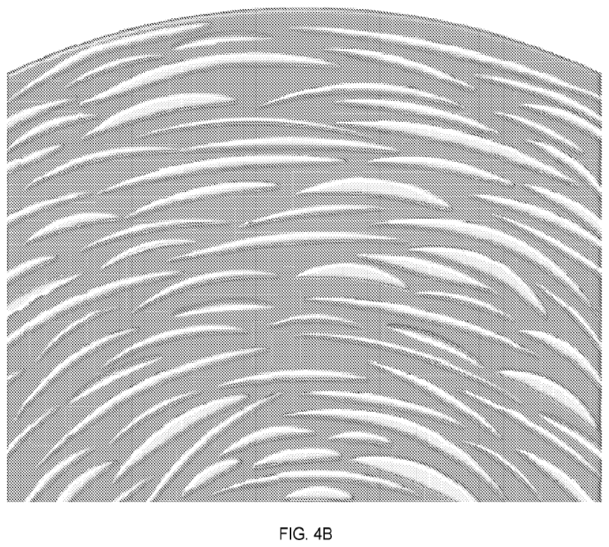

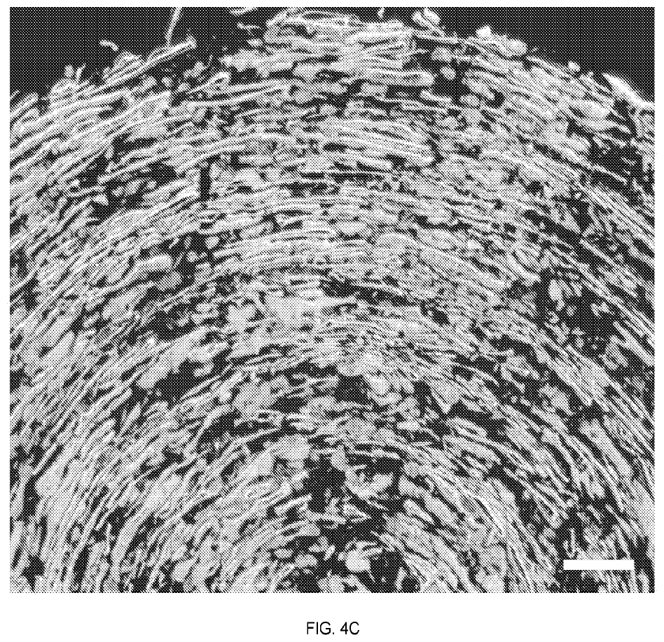

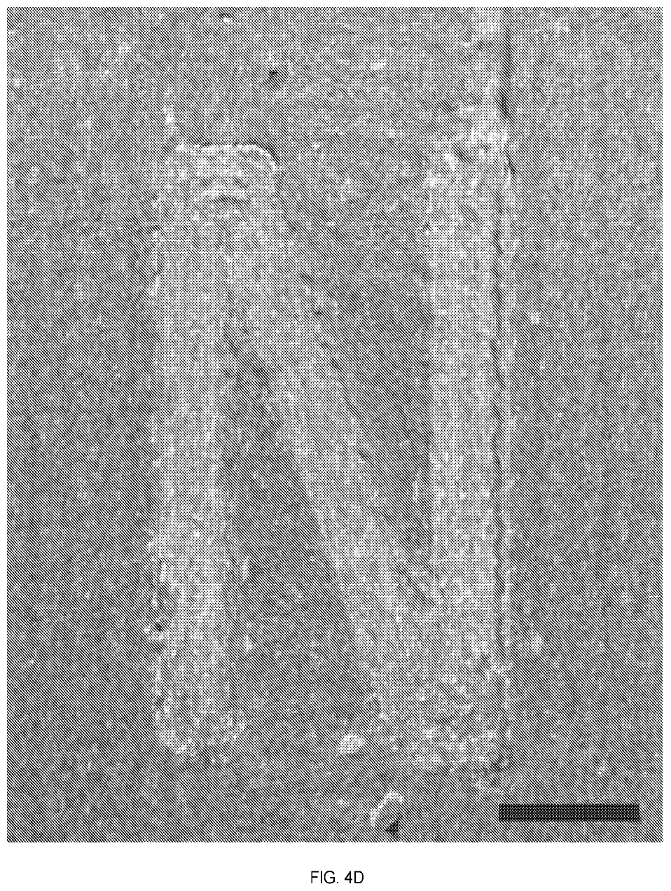

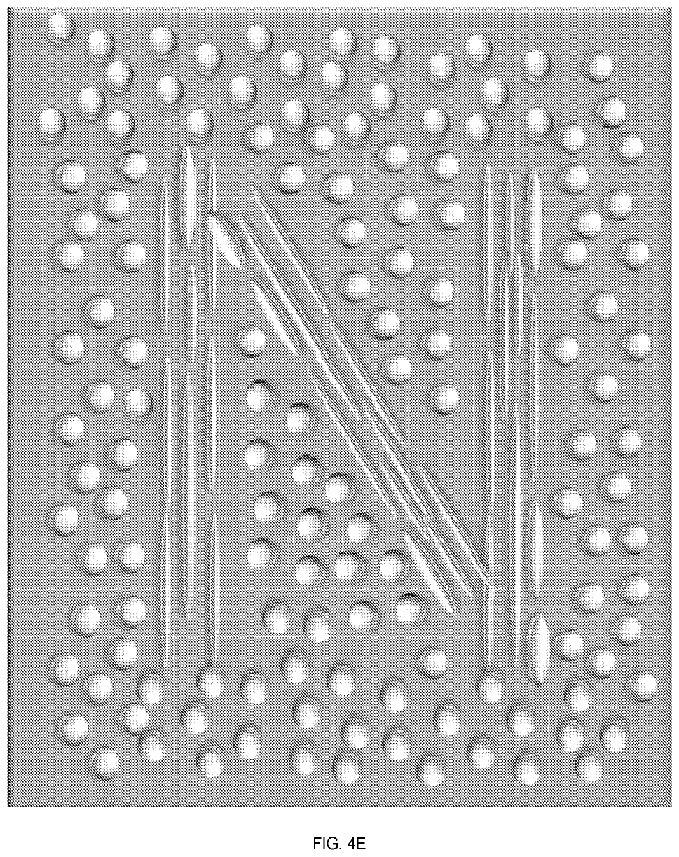

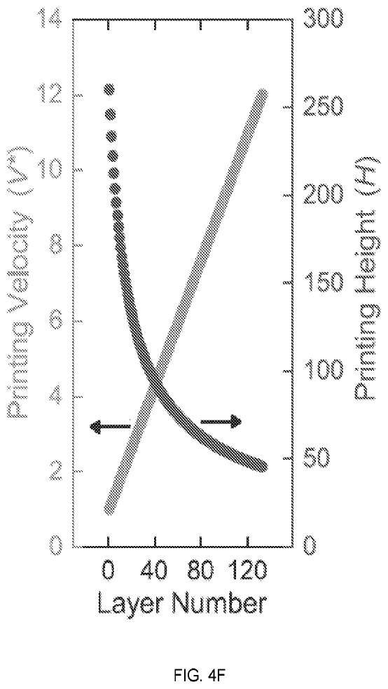

For multilayer prints, 5-mil polycarbonate film (McMaster-Carr) was used as the substrate. Each layer was partially cured before printing the next using a hot air gun set to 130° C. for 5 min, followed by cooling with a fan for 6 min. The hot air gun was attached as a print head to the H3D mounting system and controlled using an auxiliary output to provide directed heating and automate the partial curing process. The cooling fan was rigidly attached to the print bed and controlled using an auxiliary output to increase convection heat transfer. Before each layer, the syringe plunger was depressed at the desired velocity for 1 min to allow the extrusion velocity to reach equilibrium. Films containing both spherical and elongated droplets (FIG. 4D) were composed of one layer of spherical droplets printed at V*+=2, H=210 μm and three layers of elongated droplets printed at V*=12, H=70 μm, with a constant extrusion velocity of C=4.1 mm-s-1. The fully filled right angled triangular prism contains 133 layers. The printing parameters were updated each layer using the following equations: V*=1+11×((layer number-1)/132) and H=260×(V*)−0.7 μm. For multimaterial printing, a second SDS-10 print head was added to the printer, loading one print head with Ex-Sil™ 100 and the other with the LM emulsion ink. LM networks were formed with filaments that were printed as previously described using V*=4 and H=105 μm. After printing, the filament was partially cured using a hot air gun set to 130° C. for 5 min. The printed filament was then electrically activated using a tapping motion with the printing nozzle. To perform the tapping motion, the nozzle was brought to a height of H/8, moved along the desired path by 60 μm, retracted to 2H, and then moved along the desired path by 60 μm. This process was repeated until the desired LM network was formed.

### Microscopy and Particle Analysis

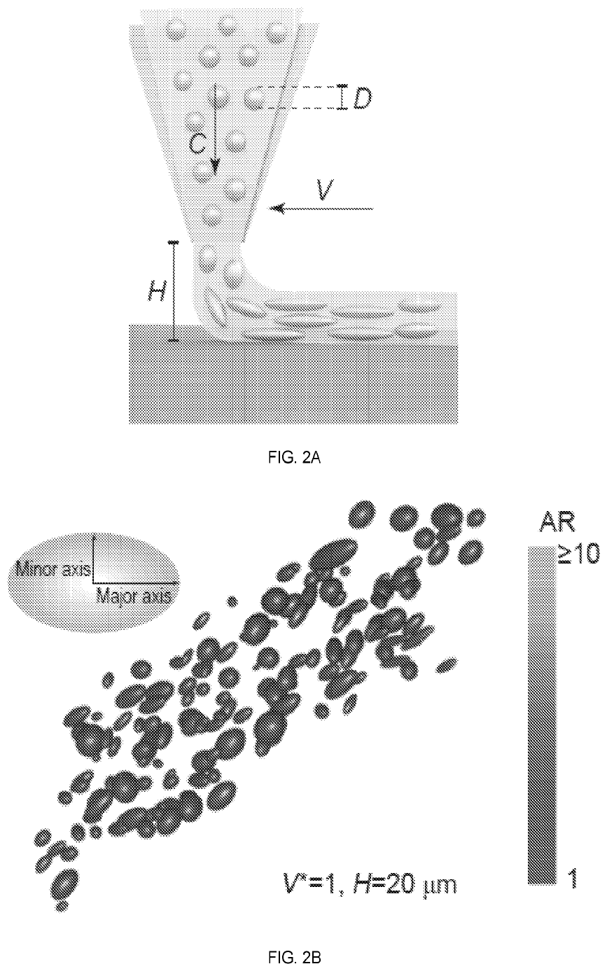

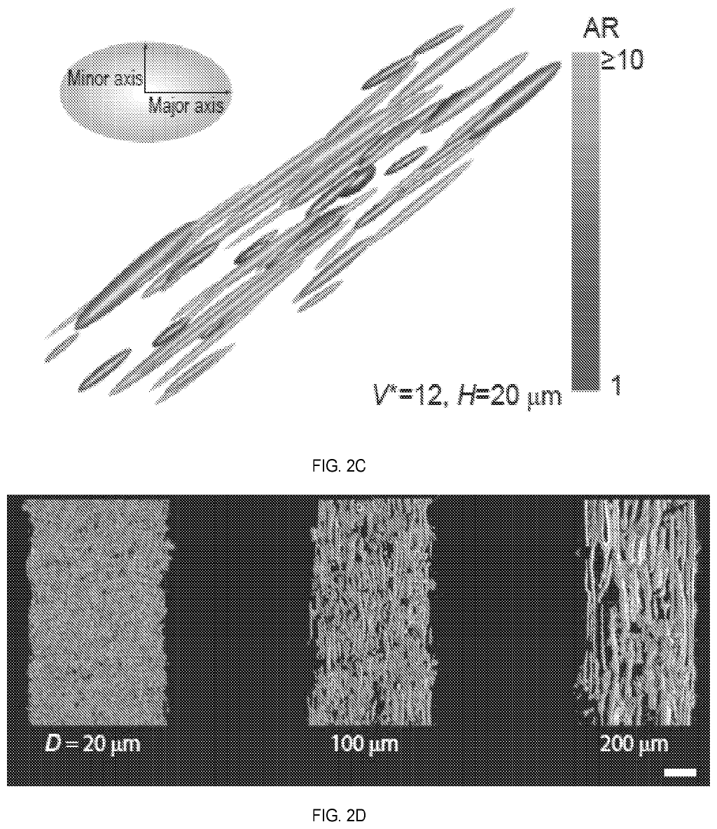

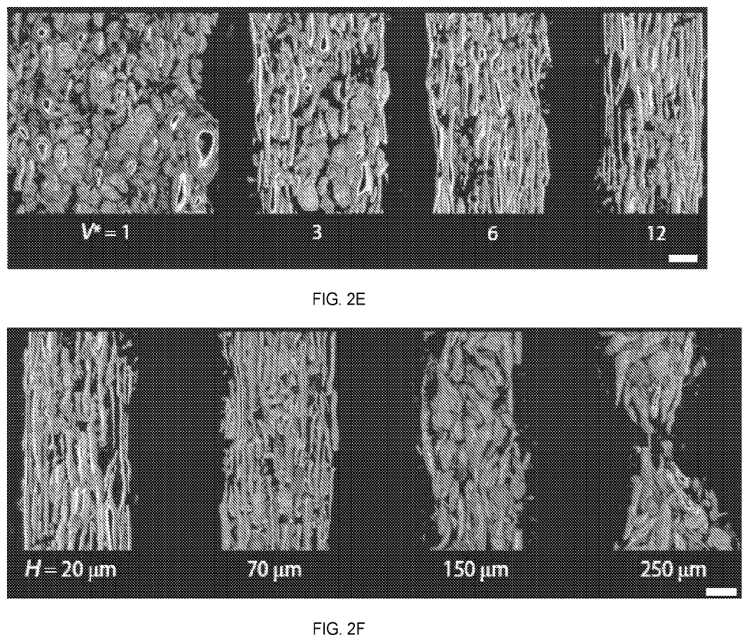

Before imaging, a layer of Sylgard 184 was deposited over each sample to reduce glare from the LM droplets. Optical micrographs were obtained using a Zeiss Axio Zoom v16 stereo microscope. Image analysis was performed using Fiji software. The LM droplets were manually outlined on the micrograph and a mask is created with dark regions for droplets and a bright background for the matrix. Gaussian fits were performed on inclusion histograms to obtain a mean and standard deviation for the distributions. Analysis for micrographs is presented in FIGS. 2A-2G. A sequence of the actual micrograph, outlines around the droplets, and the final ellipses fit on the droplets can be found in the provisional applications to which this application claims priority.

### Mechanical Characterization

Uniaxial tension tests were performed on an Instron 5944 mechanical testing machine. Printed single- and multi-filament samples were attached with tape on either end, and this section was inserted in the pneumatically controlled grips. The tested length of the filaments between the grips was approximately 40 mm. Samples were strained at an extension rate of 1 mm-s-1. The tensile modulus was calculated from the slope of the stress-strain curve up to 5% strain.

### Thermal Imaging Demonstration

Two different patterns were analyzed with elongated droplets as the letters ‘N’ and ‘VT’ and spherical droplets at other regions. The samples were kept on the 5-mil polycarbonate film and placed on a hot plate set to 50° C. IR images were captured with a FLIR A655sc IR

### Thermal Management Demonstration

LM traces were spray coated using a nitrogen-assisted masking deposition technique to form interconnects on top of the composite. Then 4 LEDs (Cree® XLamp® XHP50) were placed on the surface of the composite in contact with the LM trace. The composite was placed on an aluminum block and a current of 0.5 A was applied to the 4-LED circuit in series for 40 seconds and then switched off. An IR camera (FLIR E54sc) was used to capture the thermal distribution.

### Electrical Characterization of Printed Filaments

Electrical measurements were performed using a Fluke 117 True RMS multimeter. Stainless steel needles (25 gauge) were attached to the multimeter probes for measuring resistance of a single droplet and regions around it.

### Results and Discussion

### Direct Ink Write 3D Printing of Functional Emulsion Inks

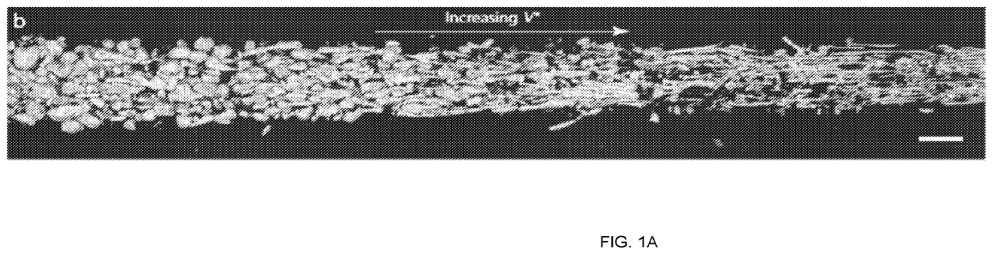

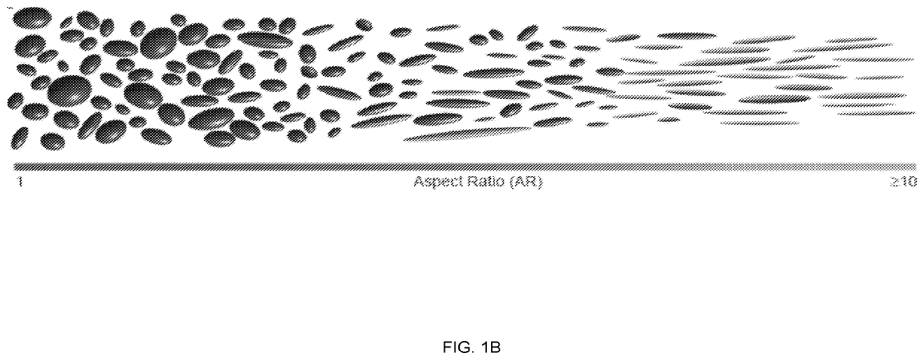

For DIW of functional emulsion inks, the ink is loaded into a syringe and the material is extruded from the nozzle at a desired flow rate using a mechanically driven syringe pump, while the nozzle is moved laterally along a substrate. The functional emulsion ink consists of LM microdroplets dispersed in a silicone prepolymer, which has been previously demonstrated._{27, 33} The emulsion ink is fabricated with three different LM microdroplet diameters (D=20, 100, 200 μm; see Experimental Section for more details). We can spatially control the orientation and AR of the LM microdroplets in the extruded filament by controlling printing parameters including the i) nondimensionalized nozzle velocity (V*=V/C) that represents the ratio of the nozzle velocity (V) to extrusion velocity (C) and ii) nozzle height (H) along a straight motion path. Systematically controlling the printing parameters V* and H results in a gradual and controlled change in the AR of the LM microdroplets with high AR fillers aligning along the printing direction (FIG. 1A). The left side of the filament in FIG. 1A, printed at low V*=1 and high H=300 μm, contains mostly spherical droplets (AR˜1). As the printing progresses towards the right side, where the nozzle velocity is increased (V*=15) and the nozzle is decreased (H=20 μm) simultaneously, there is a transition from spherical to highly elongated microstructures with AR>35. An optical micrograph of the extruded filament was analyzed and ellipses were fit to the LM droplets. This data was used to create a visualization of the printed filament microstructure in MATLAB which highlights the evolution and control of droplet morphology as shown in FIG. 1B. This demonstrates that a single AM system and functional emulsion ink can print filaments with a wide range of LM microstructures, ranging from spherical droplets (AR=1) to high AR, needle-like microstructures (AR>35) where the embedded spherical LM droplets are physically transformed at the printing nozzle and locked-in by the rapid formation of the oxide shell.

### On Demand Programming of LM Microstructure

A cross section of the printing nozzle is illustrated in FIG. 2A and indicates some of the relevant parameters in the printing process. Printed filaments were characterized using optical microscopy, and droplet analysis was performed to measure the droplet AR. FIG. 2B shows representative results using a 3D visualization from the microstructural analysis. Here, the printed filament microstructure represents a combination of V*=1, and H=20 μm, which yields mostly spherical droplets with AR≤5. As the nozzle velocity is increased to V*=12 and the printing height is maintained at H=20 μm, droplet AR>10 are observed with maximum AR approaching 40, as shown in the 3D visualization of the LM microstructures (FIG. 2C and FIG. 2G). These printed filaments with programmed microstructure represent the extremes of the evaluated process space and demonstrate the enabling role of our DIW process with functional emulsion inks to achieve on demand control of LM microstructure.

To systematically study the influence of printing parameters on the programmed LM microstructure, we independently investigated three parameters: i) the diameter (D) of the LM microdroplets in the emulsion ink, ii) the nondimensionalized nozzle velocity (V*), and iii) the height of the nozzle from the printing bed (H). The influence of LM microdroplet diameter on LM microstructure for a given printing velocity and nozzle height (V*=12, and H=20 μm) is shown in FIG. 2D. We observed that the AR of the LM microdroplets increases with increasing diameter, with emulsion inks containing D=200 μm droplets showing the highest AR after printing. The emulsion inks containing D=20 μm droplets show relatively little change in AR, which is attributed to the increase in stiffness of smaller droplets due to surface oxide and surface tension, which increases the droplets' resistance to deformation.₅₁ The AR of droplets could also be increased by increasing V* from 1 to 12 while maintaining the same printing height and droplet size (H=20 μm and D=200 μm). FIG. 2E shows the V* dependent micrographs, where the mean AR increases from 1.6 to 7.9 as V* increases from 1 to 12. However, with the same printing velocity and droplet size (V=12 and D=200 μm), AR decreases as the printing height is increased from 20 μm to 250 μm. The filaments also tend to break into sections at the highest printing height with droplet AR close to 1, as shown in FIG. 2F.

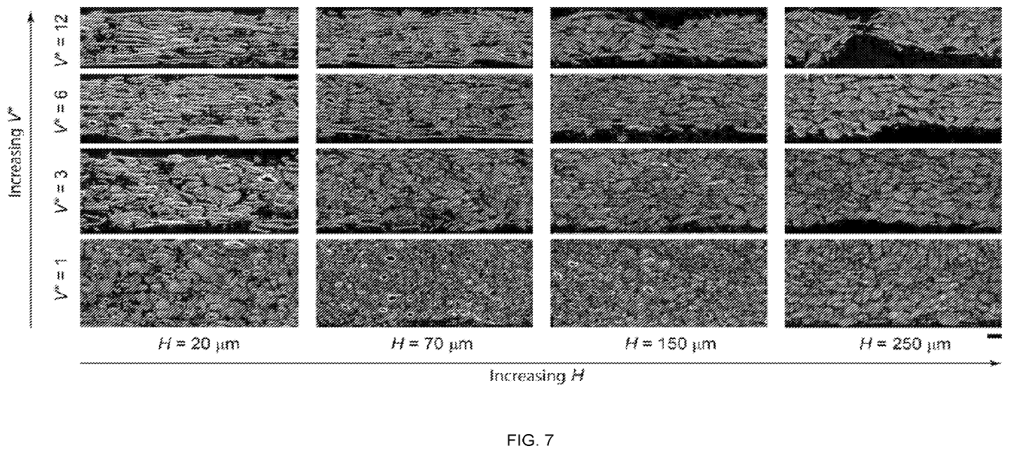

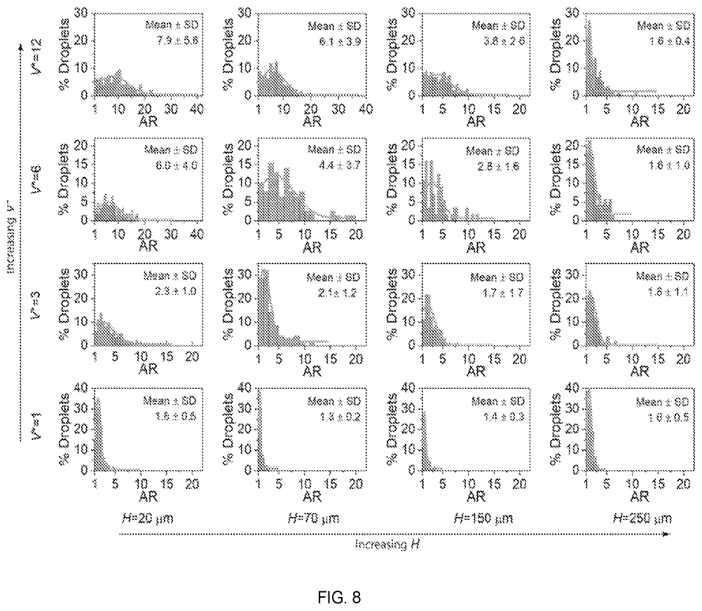

To guide the programming of LM microstructures and the selection of printing parameters for the new DIW strategy, we examined AR as a function of printing conditions. We performed particle analysis for the filaments printed with D=200 μm droplets, shown in FIGS. 2D-2F, and applied a Gaussian fit to the AR histograms. FIG. 2G shows the resulting Gaussian fits where the droplet inset shows the mean AR and the lowest and highest AR droplets are shown as the terminal x-axis values of the Gaussian fit. The highest AR resulted from the highest V* and lowest H condition (V*=12, and H=20 μm) with the AR of some droplets approaching 40. A design map was then created from 16 independent experiments, where the mean AR from the Gaussian fits were plotted as a color map as a function of the printing parameters with V* on the y-axis and H on the x-axis (FIG. 2H). The optical micrographs and Gaussian fits from the independent experiments are shown in FIG. 7 and FIG. 8, respectively. The color map shows how increasing nozzle velocity (V*) and decreasing nozzle height results in a higher mean AR. The same AR trend is observed when looking at the maximum AR achieved as a function of V* and H, as shown in the design map in the provisional applications to which this application claims priority. These quantitative design maps provide a tool to create LM-composite microstructures from generally spherical droplets to highly elongated droplets by varying the printing conditions. This allows for systematic control of material microstructure where the shape and orientation of LM inclusions can be readily tuned during composite fabrication. Although high AR solid particles can be aligned during DIW, the by plotting the mean AR as a function of the printing velocity and height we demonstrate that the AR of LM droplets can be systematically tuned on demand with alignment occurring along the printing path without modifying the base ink. Therefore, this LM emulsion printing technique controls multiple aspects of composite microstructure in a single fabrication process.

### Mechanical Properties of Printed Filaments and Films

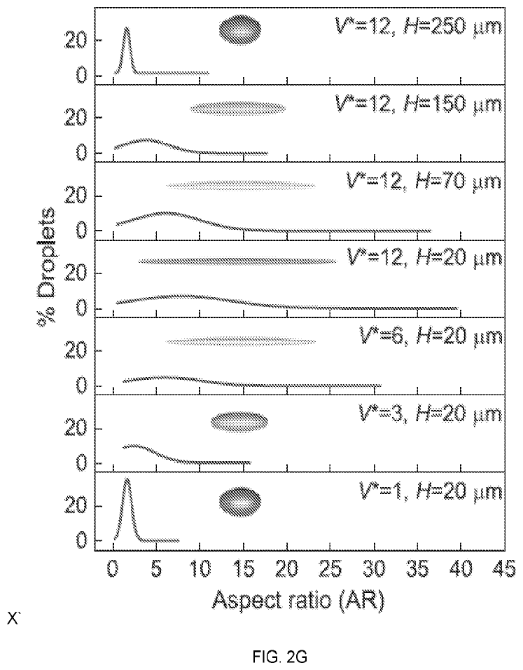

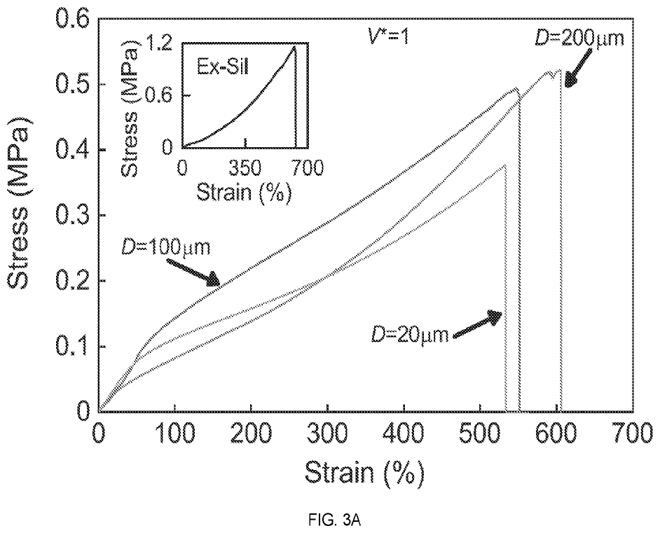

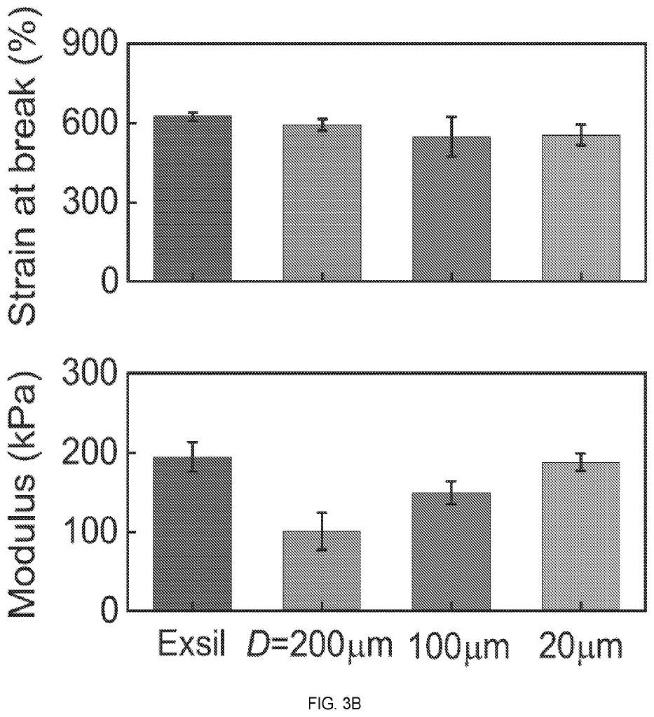

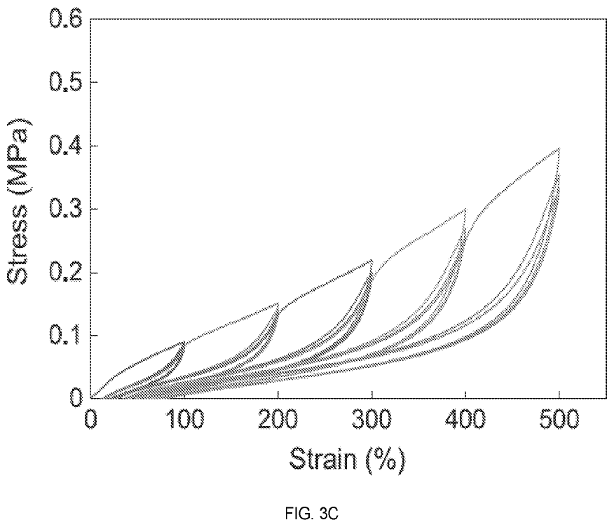

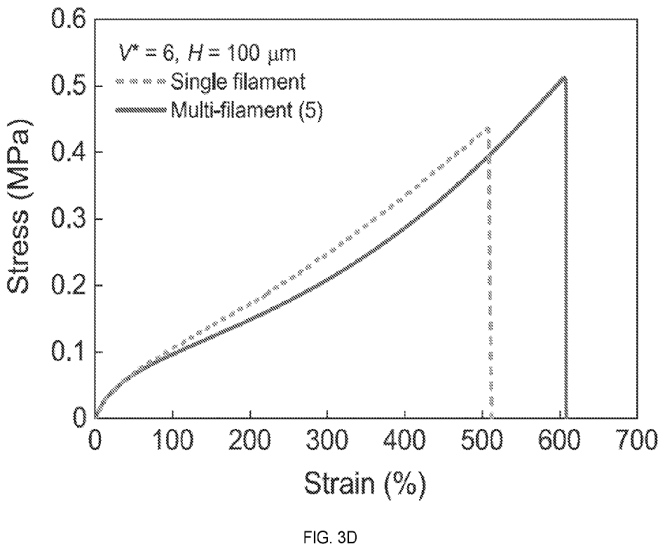

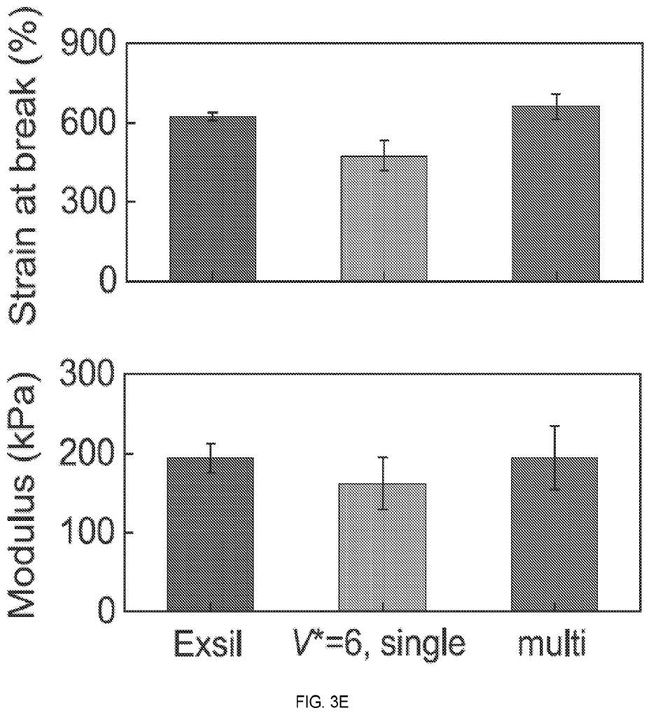

The DIW of LM-composites results in materials that are soft and highly deformable due to the combination of a soft elastomer with liquid-phase inclusions. This is demonstrated by the printed filaments capable of being stretched and easily wrapped around a human finger. To quantify their mechanical properties, the filaments were stretched in uniaxial tension until they failed and the stress-strain curves were analyzed. FIG. 3A shows the deformation behavior for filaments with V*=1, H=100 μm, and D=20, 100, 200 μm with the stress-strain curve for pristine silicone elastomer in the inset. Tensile modulus (up to 5% strain) and strain at break were calculated for each sample filament and the mean and standard deviation for three filaments are plotted in FIG. 3B. The strain at break data indicates that the printed composite filaments and silicone elastomer filaments are both highly stretchable, with failure strains of approximately 600% for all conditions. However, the tensile modulus data shows a softer response for filaments with larger LM droplets with an increasing modulus as droplet size decreases.

The printed composite filaments can also be stretched over multiple loading cycles. This was evaluated by stretching a filament printed with V*=1, H=100 μm, and D=200 μm up to 500% strain in 100% increments with 3 cycles at each increment (FIG. 3C). We see a characteristic soft composite cyclic response, where the first cycle to a given strain shows hysteresis, while subsequent loading cycles show little hysteresis. This is commonly referred to as the Mullen's effect, and is observed in many soft composites, including LM-composites that are fabricated through casting. The printing process can produce single filaments as well as multi-filament geometries. We evaluate the mechanical response of single and multi-filament samples with printing condition V*=6, H=100 μm, and D=200 μm in uniaxial tension and plotted the stress-strain curves in FIG. 3D. FIG. 3E shows that both the single and multi-filament samples with elongated LM droplets show comparable strain at break and modulus behavior to the pristine silicone elastomer. We found that the single filament geometry shows a reduced strain at break and modulus relative to the multifilament sample. We attribute this to minor inconsistencies in the cross-sectional area that likely play a more significant role in the mechanical response of single filaments relative to multi-filament geometries. In both geometries, the material was still highly extensible (strain at break ˜600%) and soft (modulus˜200 kPa), showing the ability to print soft and deformable composites with highly elongated LM inclusions.

### Programmable LM Microstructures in 2D and 3D

The DIW strategy for controlling LM microstructure throughout a printed part enables us to create single layer films and multilayer structures with varying inclusion morphology using a single ink and AM system. By following a curve instead of a straight motion path, we could create nonlinear, high AR LM microstructures with shapes that mimic the print path. Here, we demonstrated this ability by printing a spiral pattern. The optical micrograph of the printed film is shown in FIG. 4A. A section of the printed film is highlighted and a schematic illustration and optical micrograph is shown in FIG. 4B and FIG. 4C, respectively. In addition to creating printed parts with homogeneous microstructure, the printing conditions (V*, H) can be actively tailored throughout the printing process to achieve spatial control of the LM microstructure. Here, discrete transitions in microstructure were achieved by controlling the printing conditions to attain alternating paths of low AR (V*=2, H=210 μm, D=200 μm) and high AR (V*=12, H=70 μm, D=200 μm) LM droplets. A section of the printed film is highlighted and a schematic illustration and optical micrograph were observed, respectively. Smooth, continuous transitions from spherical to needle-like microstructures can also be achieved in a single filament (FIG. 1A) or throughout a printed film.

To further demonstrate the ability to spatially control the LM microstructure, microstructural patterns can be embedded in the printed structure. This allows for the embedding of different functional properties throughout a part. We demonstrated spatial control of LM microstructure by printing the letter ‘N’ with high AR (V*=12, H=70 μm, and D=200 μm) LM droplets, with spherical (V*=2, H=210 μm, and D=200 μm) LM droplets surrounding the letter. FIG. 4E shows a schematic illustration of the programmed LM microstructure shown in FIG. 4D. When the sample is uniformly heated, the difference in LM microstructure results in a difference in heat transfer characteristics and the letter ‘N’ is visible when viewed with an infrared (IR) camera (pictures available in the priority document). As expected, the letter ‘N’ that is constructed with needle-like microstructures remains at a lower temperature than the surrounding matrix due to the higher thermal conductivity. A similar IR image of a printed film that contains the printed letters ‘VT’ with high AR LM microstructures demonstrated similar results (also available in the priority document). Finally, we demonstrated the ability of DIW to program LM microstructure in multilayer and 3D structures. First, a ten-layer structure was created, where each layer is printed with high AR LM droplets. Similar LM microstructures were observed throughout the multilayer structure, as shown in the optical micrographs of the first and final layer of the printed film. We expand upon this homogeneous multilayer structure and show that LM microstructure can also be varied throughout a 3D structure by controlling the printing parameters V* and H for each individual layer (FIG. 4F). Here we program a smooth transition from spherical (V*>=2, H=260 μm, and D=200 μm) to high AR (V*=12, H=45 μm, and D=200 μm) LM droplets to print a fully filled right angled triangular prism as shown in FIG. 4G. This manufacturing strategy allows us to change the LM droplet microstructure throughout the printing process, as shown in the optical micrographs (FIG. 4G right). The printed films and 3D structures emphasize the versatility of our new approach to spatially tailor the LM droplet microstructure throughout a 2D or 3D printed part. This allows us to achieve geometrically complex LM microstructures that can not be created through film casting, mechanical deformation, magnetic alignment, replica molding, or lithography.

### Multilayer, Multimaterial DIW 3D Printing for Thermal Management

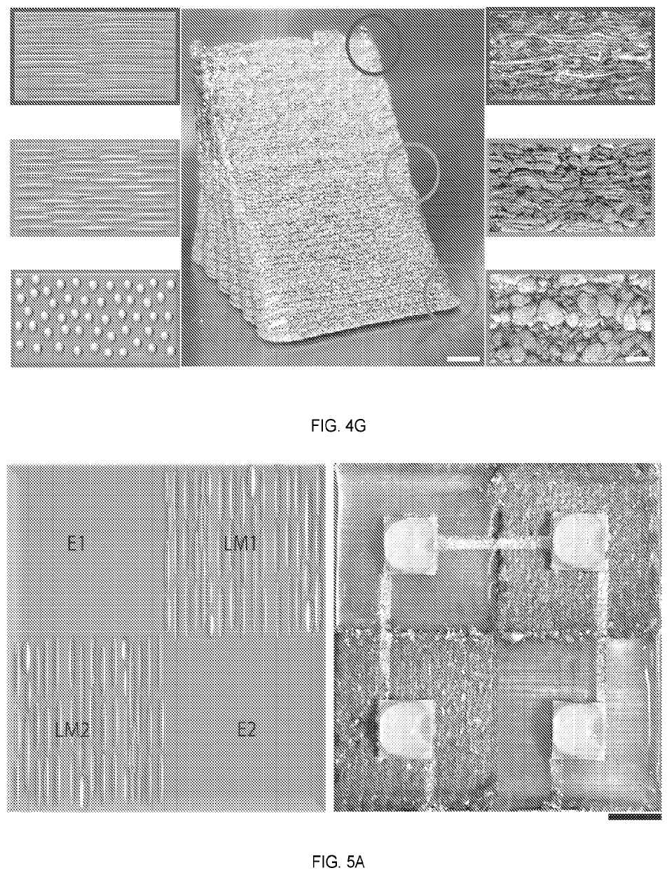

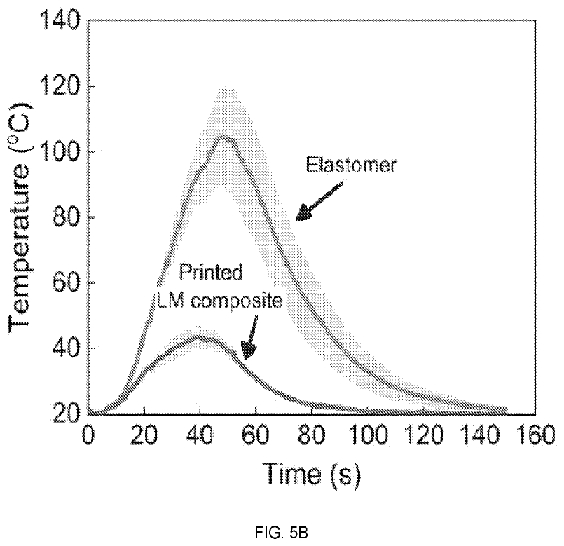

To further demonstrate the versatility of the DIW strategy to program LM-composite microstructures, we printed a multilayer, multimaterial soft heat sink. We utilized two extrusion-based print heads to create a 15-layer part with two regions of pure silicone elastomer (E1, E2) and two regions of LM-composite containing oriented LM droplets (LM1, LM2) using the following printing parameters V*=12, H=70 μm, and D=200 μm. A schematic illustration of the programmed LM microstructure is shown in FIG. 5A (left). After printing, we assembled an LED circuit on the part surface with high power LEDs connected in series with LM interconnects (FIG. 5A, right). The sample was placed on an aluminum block, and a current of 0.5 A was applied to the 4-LED circuit for 40 seconds and then switched off. The high power LEDs generated a significant amount of heat while in operation, and the thermal signature of the LEDs was tracked through an IR camera. FIG. 5B (Printed LM Composite curve) shows that the LEDs in the oriented-LM regions (LM1, LM2) only reached a maximum temperature of 40° C. with a nearly symmetric heating and cooling profile, which illustrates rapid and well-controlled heat transfer. The pure silicone elastomer regions (E1, E2) accumulated heat at and around the LEDs, which reached temperatures greater than 100° C. with a slower cooling profile as shown by the Elastomer curve in FIG. 5B. A sequence of frames from the IR thermal imaging is shows that the printed LM-composite regions with programmed LM microstructures remained much cooler throughout the experiment and performed passive thermal management efficiently. This demonstration illustrates the ability to effectively control thermal dissipation at different regions throughout a printed part utilizing the DIW 3D printing process to control material composition and LM-composite microstructure throughout a multilayer part.

### LM-Composite Microstructure Control and Formation of Connected Networks

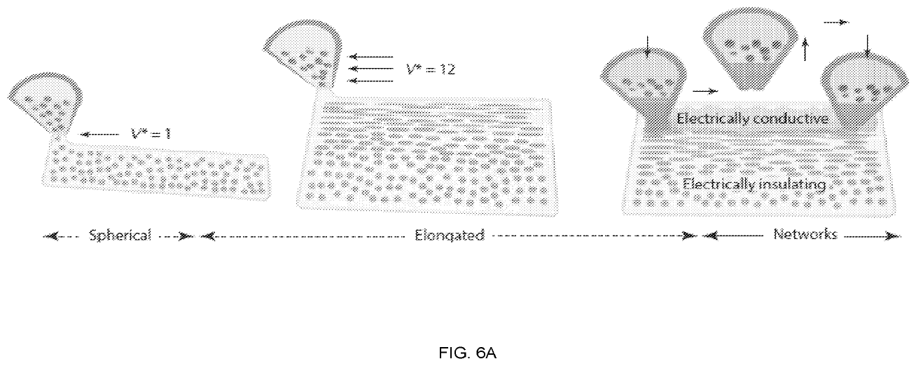

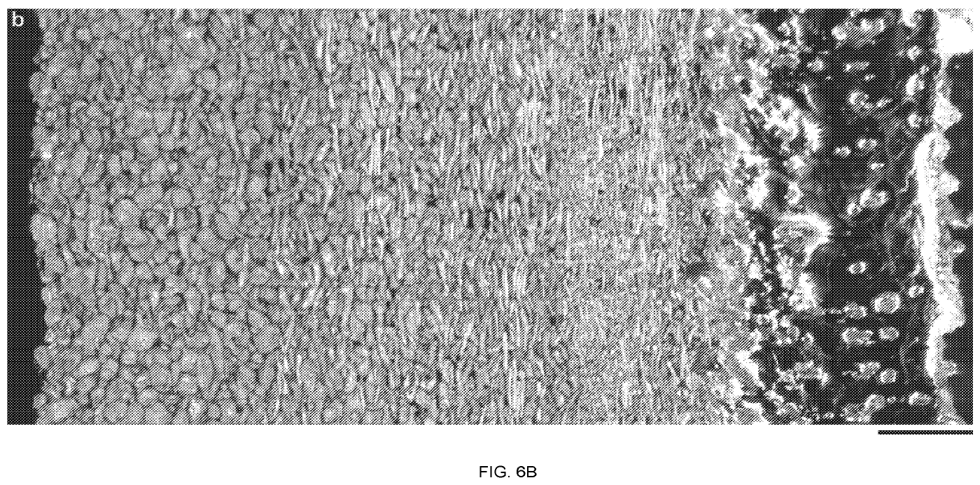

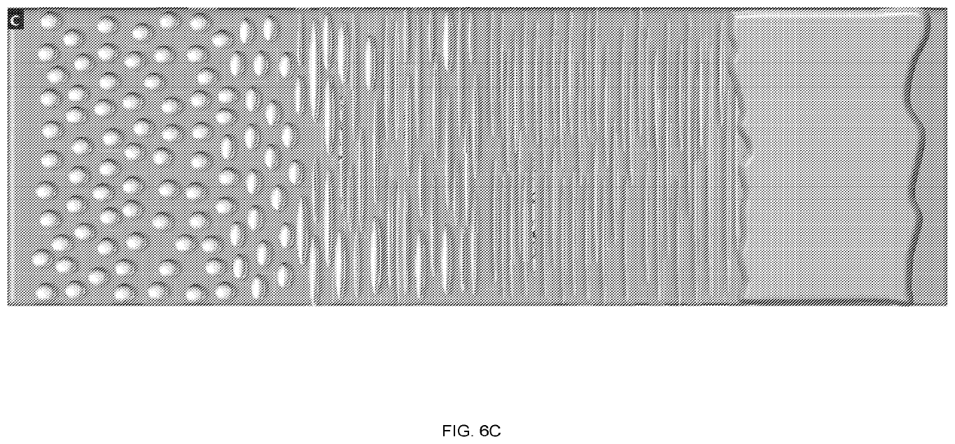

The DIW strategy for programming LM-composite microstructures enables the fabrication of 3D multilayered structures consisting of isolated LM droplets with controllable shape and orientation. These microstructures are important for applications that require electrical insulation. To enable applications where electrical conductivity is needed, the formation of LM networks is essential. Therefore, the ability to control LM microstructures form spherical to ellipsoidal to connected networks can open possibilities system to print composites with diverse functionalities. Here, using the same emulsion ink and manufacturing, we demonstrate that the initially isolated LM droplets could be printed and then reconfigured into a connected network of LM droplets to form electrically conductive traces. FIG. 6A illustrates the different print processing conditions that are utilized to achieve full control of LM droplet shape, orientation, and connectivity throughout a printed part. Leveraging the quantitative design map, a single print head and emulsion ink was used to create a single layer film with graded particle morphology (FIG. 6B). A schematic illustration of the printed film is shown in FIG. 6C. The morphology gradient was created by varying the printing parameters from V*=2, H=217 μm to V*=12, H=41 μm using D=200 μm LM droplets. The isolated droplet regions were electrically insulating at length scales greater than the droplet size. The initially isolated LM droplets can be transformed into a connected network through a tapping motion with the printing nozzle (see Experimental Section for more details). The formed LM networks were electrically conductive and can be used to create electrical circuits. The ability to print diverse LM droplet morphologies and form conductive networks using a single ink and single print head enables the fabrication of complex microstructures in soft LM-composites. With this new DIW 3D printing strategy, both insulating and electrically conductive soft materials can be rapidly fabricated with programmable properties throughout a printed part.

### Conclusion

We have demonstrated spatial control of LM droplet microstructure in elastomer composites through a DIW 3D printing process. The interplay between the printing velocity, printing height, and the LM droplet size in the DIW setup leads to controllable droplet architectures (i.e., shape, orientation, and connectivity). The liquid nature of the gallium-indium LM alloy with rapidly forming surface oxide in combination with the DIW process enables programmable architectures in a rapid single step process without the need for post processing. This allows for highly tunable microstructures throughout a manufactured part that can enable spatial programming of material properties. The nearly instantaneous formation of the LM oxide shell is key to this printing process as it allows for on-demand formation of non-spherical droplets that are rapidly locked into shape during printing. We hypothesize that the oxide shell prevents surface tension from restoring the droplet to a spherical shape. The rapid oxide formation coupled with the droplet elongation generated during printing enables the on-demand creation of unique microstructures in the printed filament, including smooth and discrete transitions from spherical to needle-like droplets with ARs as high as 40, curvilinear microstructures, connected LM networks, and geometrically complex embedded inclusion patterns. We demonstrate the spatial LM microstructure control by creating films and 3D structures with unique LM microstructure gradients and patterns. Although we demonstrated the functionality of the printing process by creating a passive heat spreader for an LED circuit, the new DIW 3D printing process could be utilized to print parts with programmable and anisotropic properties for actuators, sensors, and circuits for soft robotics and electronics. The combination of the solid-liquid composites with our new DIW fabrication approach provides capabilities and insights to the AM and LM communities to develop advanced materials and devices with exceptional multifunctional capabilities.

### Example 2. Comparison of Direct Ink Writing with Varying Ink Formulations

Droplet aspects ratios were compared for varying print conditions including varying the droplet diameter (D), varying the print velocity (V*) and varying the height (H). For some of the larger droplets (e.g. the 200-micron GaIn droplets), hexane is mixed in the elastomer matrix to reduce viscosity for mixing and then evaporated prior to printing. The methods mirrored those for Example 1 unless indicated otherwise.

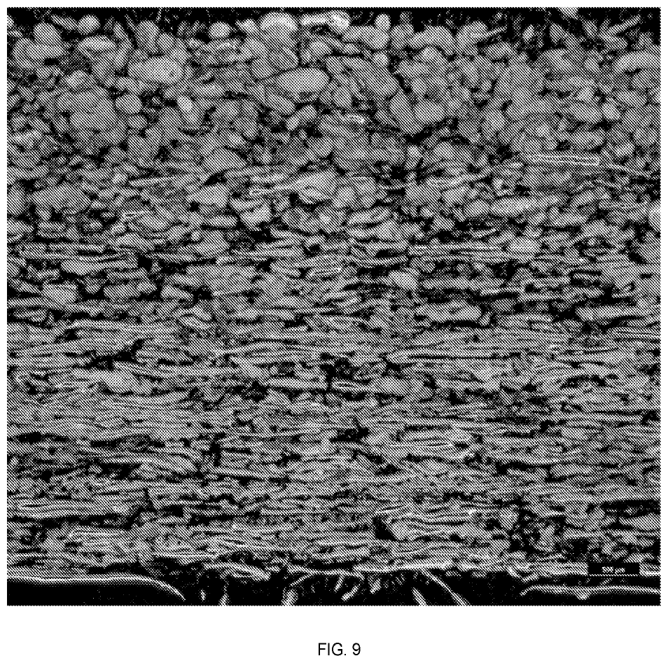

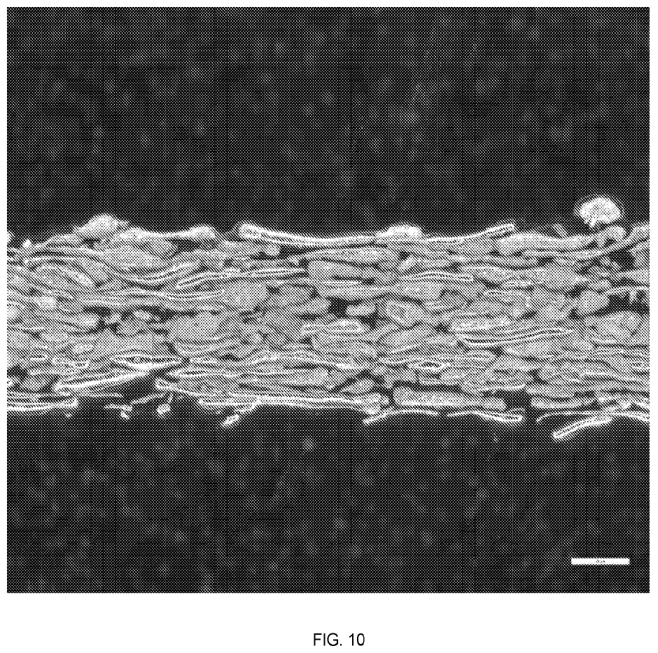

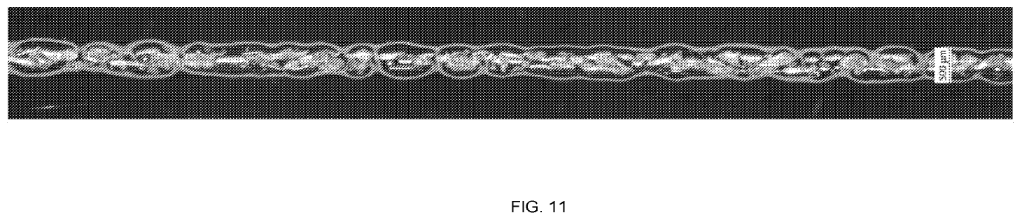

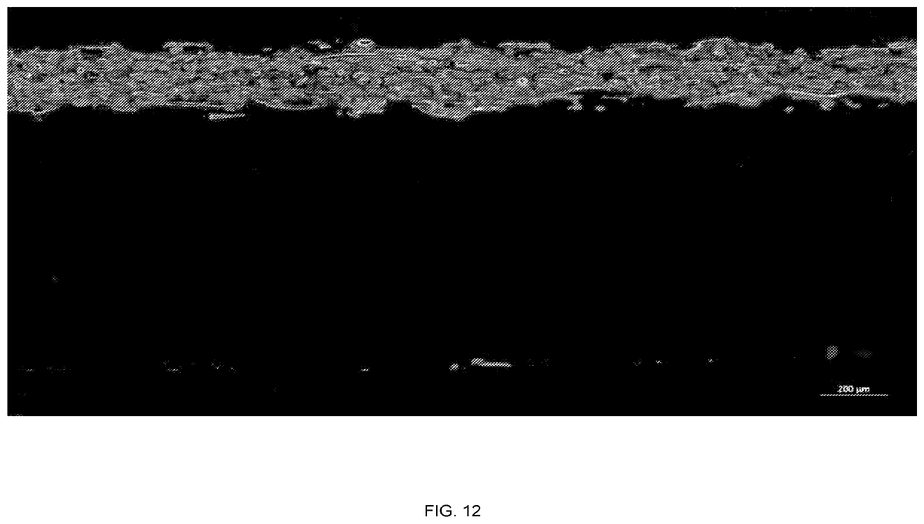

Elastomer matrices tested include the two-component silicone elastomer Ex-Sil™ 100; Gelest Inc from Example 1, as well as the platinum catalyzed silicone elastomer Ecoflex™ 00-30, the SYLGARD™ 184 Silicone Elastomer, and the DOWSIL™ SE 1700 polydimethylsiloxane matrix. LM concentrations ranged from 30 vol % to 50 vol %. As demonstrated in FIGS. 2D-2F and FIGS. 9-12, elongated droplets with high average aspect ratios were able to be achieved in all systems.

It should be emphasized that the above-described aspects of the present disclosure are merely possible examples of implementations and are set forth only for a clear understanding of the principles of the disclosure. Many variations and modifications may be made to the above-described aspects of the disclosure without departing substantially from the spirit and principles of the disclosure. All such modifications and variations are intended to be included herein within the scope of this disclosure.

### REFERENCES

The following references are provided to assist in better understanding the disclosure and technologies described therein. The citation of any publication is for disclosure purposes only and should not be construed as an admission that the publication is material in any way to patentability of the claims nor that the present disclosure is not entitled to antedate such publication by virtue of prior disclosure. Further, the dates of publication provided could be different from the actual publication dates that may need to be independently confirmed. References are cited herein throughout using the format of reference number(s) in superscript corresponding to one or more of the following numbered references. For example, citation of references numbers 1 and 2 immediately herein below would be indicated in the disclosure as (Refs.^{1,2}).
[1] R. L. Truby, J. A. Lewis, Nature 2016, 540, 7633 371.
[2] H. Yuk, X. Zhao, Advanced Materials 2018, 30, 6 1704028.
[3] T. Wallin, J. Pikul, R. Shepherd, Nature Reviews Materials 2018, 3, 6 84.
[4] S. Abdollahi, E. J. Markvicka, C. Majidi, A. W. Feinberg, Advanced Healthcare Materials 2020, 201901735.
[5] A. Lee, A. Hudson, D. Shiwarski, J. Tashman, T. Hinton, S. Yerneni, J. Bliley, P. Campbell, A. Feinberg, Science 2019, 365, 6452 482.
[6] D. J. Braconnier, R. E. Jensen, A. M. Peterson, Additive Manufacturing 2020, 31 100924.
[7] Y. Kim, H. Yuk, R. Zhao, S. A. Chester, X. Zhao, Nature 2018, 558, 7709 274.
[8] S. Gantenbein, K. Masania, W. Woigk, J. P. Sesseg, T. A. Tervoort, A. R. Studart, Nature 2018, 561, 7722 226.
[9] Q. Ge, H. J. Qi, M. L. Dunn, Applied Physics Letters 2013, 103, 13 131901.
[10] A. S. Gladman, E. A. Matsumoto, R. G. Nuzzo, L. Mahadevan, J. A. Lewis, Nature materials 2016, 15, 4 413.
[11] M. Wehner, R. L. Truby, D. J. Fitzgerald, B. Mosadegh, G. M. Whitesides, J. A. Lewis, R. J. Wood, Nature 2016, 536, 7617 451.
[12] D. K. Patel, A. H. Sakhaei, M. Layani, B. Zhang, Q. Ge, S. Magdassi, Advanced Materials 2017, 29, 15 1606000.
[13] M. A. Skylar-Scott, J. Mueller, C. W. Visser, J. A. Lewis, Nature 2019, 575, 7782 330.
[14] A. D. Valentine, T. A. Busbee, J. W. Boley, J. R. Raney, A. Chortos, A. Kotikian, J. D. Berrigan, M. F. Durstock, J. A. Lewis, Advanced Materials 2017, 29, 40 1703817.
[15] J. Odent, T. J. Wallin, W. Pan, K. Kruemplestaedter, R. F. Shepherd, E. P. Giannelis, Advanced Functional Materials 2017, 27, 33 1701807.
[16] J. T. Muth, D. M. Vogt, R. L. Truby, Y. MengBu_c, D. B. Kolesky, R. J. Wood, J. A. Lewis, Advanced Materials 2014, 26, 36 6307.
[17] M. G. Mohammed, R. Kramer, Advanced Materials 2017, 29, 19 1604965.
[18] I. D. Joshipura, H. R. Ayers, C. Majidi, M. D. Dickey, Journal of materials chemistry c 2015, 3, 163834.
[19] S. Z. Guo, K. Qiu, F. Meng, S. H. Park, M. C. McAlpine, Advanced Materials 2017, 29, 27 1701218.
[20] J. W. Boley, E. L. White, G. T. C. Chiu, R. K. Kramer, Advanced Functional Materials 2014, 24, 233501.
[21] M. D. Dickey, R. C. Chiechi, R. J. Larsen, E. A. Weiss, D. A. Weitz, G. M. Whitesides, Advanced Functional Materials 2008, 18, 7 1097.
[22] T. Liu, P. Sen, C. J. Kim, Journal of Microelectromechanical Systems 2011, 21, 2 443.
[23] M. A. Creighton, M. C. Yuen, M. A. Susner, Z. Farrell, B. Maruyama, C. E. Tabor, Langmuir 2020, 36, 43 12933.
[24] M. D. Dickey, Advanced Materials 2017, 29, 27 1606425.
[25] Z. Ma, Q. Huang, Q. Xu, Q. Zhuang, X. Zhao, Y. Yang, H. Qiu, Z. Yang, C. Wang, Y. Chai, Z. Zheng, Nature Materials 2021, 20, 6 859.
[26] N. Kazem, M. D. Bartlett, C. Majidi, Advanced Materials 2018, 1706594.
[27] R. Tutika, S. H. Zhou, R. E. Napolitano, M. D. Bartlett, Advanced Functional Materials 2018, 28, 45 1804336.
[28] M. I. Ralphs, N. Kemme, P. B. Vartak, E. Joseph, S. Tipnis, S. Turnage, K. N. Solanki, R. Y. Wang, K. Rykaczewski, ACS applied materials & interfaces 2018, 10, 2 2083.
[29] M. H. Malakooti, N. Kazem, J. Yan, C. Pan, E. J. Markvicka, K. Matyjaszewski, C. Majidi, Advanced Functional Materials 2019, 1906098.
[30] R. Tutika, S. Kmiec, A. T. Haque, S. W. Martin, M. D. Bartlett, ACS applied materials & interfaces 2019, 11, 19 17873.
[31] J. Wang, G. Cai, S. Li, D. Gao, J. Xiong, P. S. Lee, Advanced Materials 2018, 30, 16 1706157.
[32] A. Kataruka, S. B. Hutchens, Soft Matter 2019, 15, 47 9665.
[33] E. J. Krings, H. Zhang, S. Sarin, J. E. Shield, S. Ryu, E. J. Markvicka, Small 2021, 2104762.
[34] M. J. Ford, C. P. Ambulo, T. A. Kent, E. J. Markvicka, C. Pan, J. Malen, T. H. Ware, C. Majidi, Proceedings of the National Academy of Sciences 2019, 116, 43 21438.
[35] C. Pan, E. J. Markvicka, M. H. Malakooti, J. Yan, L. Hu, K. Matyjaszewski, C. Majidi, Advanced Materials 2019, 31, 23 1900663.
[36] P. Testa, R. W. Style, J. Cui, C. Donnelly, E. Borisova, P. M. Derlet, E. R. Dufresne, L. J. Heyderman, Advanced Materials 2019, 1900561.
[37] B. S. Chang, R. Tutika, J. Cutinho, S. Oyola-Reynoso, J. Chen, M. D. Bartlett, M. M. Thuo, Materials Horizons 2018, 5, 3 416.
[38] T. L. Buckner, M. C. Yuen, S. Y. Kim, R. Kramer-Bottiglio, Advanced Functional Materials 2019, 1903368.
[39] E. J. Markvicka, M. D. Bartlett, X. Huang, C. Majidi, Nature materials 2018, 17, 7 618.
[40] E. J. Markvicka, R. Tutika, M. D. Bartlett, C. Majidi, Advanced Functional Materials 2019, 1900160.
[41] J. W. Boley, E. L. White, R. K. Kramer, Adv. Mater. 2015, 27, 14 2355.
[42] Y. Lin, C. Cooper, M. Wang, J. J. Adams, J. Genzer, M. D. Dickey, Small 2015, 11, 48 6397.
[43] C. J. Thrasher, Z. J. Farrell, N. J. Morris, C. L. Willey, C. E. Tabor, Advanced Materials 2019, 31, 40 1903864.
[44] S. Liu, M. C. Yuen, E. L. White, J. W. Boley, B. Deng, G. J. Cheng, R. Kramer-Bottiglio, ACS applied materials & interfaces 2018, 10, 33 28232.
[45] M. D. Bartlett, N. Kazem, M. J. Powell-Palm, X. Huang, W. Sun, J. A. Malen, C. Majidi, Proc. Natl Acad Sci. USA 2017, 201616377.
[46] M. D. Bartlett, M. D. Dickey, C. Majidi, NPG Asia Materials 2019, 11, 1 1.
[47] R. Tutika, A. T. Haque, M. D. Bartlett, Communications Materials 2021, 2, 1 1.
[48] S. Liu, D. S. Shah, R. Kramer-Bottiglio, Nature Materials 2021, 20, 6 851.
[49] A. Fassler, C. Majidi, Advanced Materials 2015, 27, 11 1928.
[50] A. T. Haque, R. Tutika, R. L. Byrum, M. D. Bartlett, Advanced Functional Materials 2020, 2000832.
[51] R. W. Style, R. Tutika, J. Y. Kim, M. D. Bartlett, Advanced Functional Materials 2021, 31, 12005804.
[52] S. Chen, H. Z. Wang, R. Q. Zhao, W. Rao, J. Liu, Matter 2020, 2, 6 1446.
[53] C. Ma, S. Wu, Q. Ze, X. Kuang, R. Zhang, H. J. Qi, R. Zhao, ACS Applied Materials & Interfaces 2020, 13, 11 12639.
[54] A. Kotikian, R. L. Truby, J. W. Boley, T. J. White, J. A. Lewis, Advanced Materials 2018, 30, 10 1706164.
[55] D. J. Roach, X. Kuang, C. Yuan, K. Chen, H. J. Qi, Smart Materials and Structures 2018, 27, 12 125011.
[56] B. G. Compton, J. A. Lewis, Advanced materials 2014, 26, 34 5930.
[57] G. Franchin, H. S. Maden, L. Wahl, A. Baliello, M. Pasetto, P. Colombo, Materials 2018, 11, 4 515.
[58] H. L. Tekinalp, V* Kunc, G. M. Velez-Garcia, C. E. Duty, L. J. Love, A. K. Naskar, C. A. Blue, S. Ozcan, Composites Science and Technology 2014, 105 144.
[59] L. y. Zhou, J. z. Fu, Q. Gao, P. Zhao, Y. He, Advanced Functional Materials 2019, 1906683.
[60] T. V. Neumann, E. G. Facchine, B. Leonardo, S. Khan, M. D. Dickey, Soft Matter 2020, 16, 28 6608.
[61] R. Tandel, B. A. Gozen, Journal of Materials Processing Technology 2021, 117470.
[62] L. y. Zhou, J. h. Ye, J. z. Fu, Q. Gao, Y. He, ACS Applied Materials & Interfaces 2020, 12 10 12068.

1. A method of additive manufacturing of an article comprising a composite material; the method comprising:
(a) extruding a first emulsion ink composition through a first nozzle to form a first layer of a composite material in a pattern that corresponds to a first layer of an article; wherein the first emulsion ink composition comprises a plurality of discrete droplets of a liquid inclusion composition dispersed within a prepolymer composition; wherein the composite material comprises a plurality of microstructures formed from the liquid inclusion composition embedded within a polymer matrix formed from the prepolymer composition; and wherein a first nozzle height and a first nozzle velocity at which the first emulsion ink composition is extruded from the first nozzle are chosen to control one or more of a shape of a microstructure, an aspect ratio of a microstructure, and a connectivity of microstructures in the plurality of microstructures in the first layer of the article.

2. The method of claim 1, further comprising:
(b) extruding a second emulsion ink composition through a second nozzle to form a subsequent layer of a composite material in a pattern that corresponds to a subsequent layer of the article; wherein the subsequent later is formed on either the first layer of the article or another subsequent layer of the article; wherein the second emulsion ink composition comprises a plurality of discrete droplets of a liquid inclusion composition dispersed within a prepolymer composition; wherein the subsequent layer of the composite material comprises a plurality of microstructures formed from the liquid inclusion composition embedded within a polymer matrix formed from the prepolymer composition; and wherein a second nozzle height and a second nozzle velocity at which the second emulsion ink composition is extruded from the nozzle are chosen to control one or more of a shape of a microstructure, an aspect ratio of a microstructure, and a connectivity of a microstructure in the plurality of microstructures in the second layer of the article.

3. The method according to claim 2, wherein step (b) is repeated multiple times to form the article in a layer-by-layer approach.

4. The method of claim 1, wherein the aspect ratio of at least one of the microstructures formed from the inclusion composition is from about 3 up to about 500.

5. The method of claim 1, wherein the mean aspect ratio of the microstructures formed from the inclusion composition is from about 1 to about 500.

6. (canceled)

7. (canceled)

8. (canceled)

9. (canceled)

10. The method of claim 1, wherein the inclusion composition comprises a liquid metal.

11. The method of claim 1, wherein the inclusion composition includes a surface tension modifier.

12. The method of claim 10, wherein the liquid metal is selected from the group consisting of gallium (Ga), rubidium (Rb), cesium (Cs), francium (Fr), indium (In), bismuth (Bi), tin (Sn), cadmium (Cd), thallium (TI), antimony (Sb), alloys thereof and alloys with other elements, and mixtures thereof.

13. The method according to claim 10, wherein the liquid metal comprises a gallium-indium alloy.

14. (canceled)

15. (canceled)

16. The method of claim 1, wherein the prepolymer composition comprises an elastomer, and
wherein the elastomer comprises silicone, polyurethane, thermoplastic elastomers, or a combination thereof.

17. (canceled)

18. The method of claim 1, wherein the prepolymer composition comprises a thermoset, wherein the thermoset is selected from the group consisting of epoxies, polyesters, polyurethanes, polyimides, acrylonitriles, copolymers thereof, and blends thereof.

19. The method of claim 1, wherein the prepolymer composition comprises a thermoplastic, wherein the thermoplastic is selected from the group consisting of polyolefins, polystyrenes, polyesters, polycarbonates, nylons, acrylics, polyacrylates, butyl, polybutenes, polyisobutylenes, liquid crystal polymers (LCP), ethylene copolymers, vinyl chloride, polyvinyl chloride (PVC), ionomers, ketones, polyamides, polyether block amide (PBA), polyphenylene oxide (PPO), polyphenylene sulphide (PPS), copolymers thereof, and blends thereof.

20. (canceled)

21. The method of claim 1, wherein the droplets of the liquid inclusion composition in the first emulsion ink are from about 5 μm and up to about 800 μm in diameter, wherein the diameter of a given droplet is defined as the diameter of a perfectly spherical droplet comprising the same volume of the droplet.

22. (canceled)

23. (canceled)

24. The method of claim 1, further comprising
(b or c) disturbing the first layer of the composite material to interconnect one or more distinct microstructures of inclusion material.

25. The method according to claim 24, wherein one or both of the first nozzle height and the first nozzle velocity are chosen to interconnect two or more of the droplets to form interconnected microstructures.

26. (canceled)

27. (canceled)

28. (canceled)

29. (canceled)

30. (canceled)

31. (canceled)

32. (canceled)

33. The method of claim 1, wherein one or both of the first layer of the composite material and the subsequent layer of the composite material are cured using one or more of heat and UV light to form the polymer matrix.

34. The method of claim 1, wherein one or both of the first nozzle height and the first nozzle velocity are controllably modified as the first layer is extruded so that one or more of a shape of a microstructure, an aspect ratio of a microstructure, and a connectivity of microstructures varies across the first layer.

35. (canceled)

36. (canceled)

37. The method according to claim 1, wherein the first emulsion ink and the second emulsion ink are the same.

38. (canceled)

39. (canceled)

40. An article formed by a method according to claim 1.

41. An article comprising an inclusion composition and a polymer matrix wherein the inclusion composition is dispersed within the polymer matrix as distinct microstructures of inclusion material; wherein the mean aspect ratio of the microstructures of inclusion material is from about 1.5 up to about 500.

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)
